(19) United States
(12) Patent Application Publication
(10) Pub. No.: US 2012/0008171 A1
(43) Pub. Date: Jan. 12, 2012

(54) IMAGE PROCESSING APPARATUS, IMAGE FORMING APPARATUS, AND COMPUTER READABLE MEDIUM

(75) Inventors: Keiichi OKADA, Kanagawa (JP); Noribumi SATO, Kanagawa (JP); Mitsuru IIOKA, Kanagawa (JP); Jun KOYATSU, Kanagawa (JP); Kaoru YAMAUCHI, Kanagawa (JP); Hatsuho AJIMA, Kanagawa (JP)

(73) Assignee: FUJI XEROX CO., LTD., Tokyo (JP)

(21) Appl. No.: 13/076,509

(22) Filed: Mar. 31, 2011

(30) Foreign Application Priority Data
Jul. 9, 2010 (JP) 2010-157076

(51) Int. Cl. G06K 15/02

(52) U.S. Cl. 358/3.28

(57) ABSTRACT

The image processing apparatus includes a combining module that respectively combine a plurality of first patterns and a plurality of second patterns each corresponding to the first patterns. Respective densities of the first patterns are different from each other. At least one of the second patterns include a plurality of regions where respective coverages are different in a main scanning direction.

### CROSS-REFERENCE TO RELATED APPLICATIONS

This application is based upon and claims priority under 35 USC 119 from Japanese Patent Application No. 2010-157076, filed Jul. 9, 2010.

### BACKGROUND

1. Technical Field

The present invention relates to an image processing apparatus, an image forming apparatus, and a computer readable medium.

2. Related Art

In the case where documents having high confidentiality such as documents for internal use only is to be printed, in order to suppress unauthorized copying and forgery of the documents, conventionally, a print process is performed on a dedicated sheet called ‘sakura gami’ or the like in which, when a copy process is performed on the sheet by a copier, characters or the like appear on the surface of the copied sheet.

A technique of printing a ground tint pattern is known in which, when a copier performs a copy process on a plain sheet, characters or the like appear on the surface of the copied sheet in a similar manner as the case of ‘sakura gami’. In the ground tint pattern printing technique, “hidden character portion” which appears as a result of a copy process is output in a low-density pattern, and “ground portion” which is formed as a white portion as a result of a copy process is output in a high-density pattern.

### SUMMARY OF THE INVENTION

According to an aspect of the invention, an image processing apparatus includes a combining module that respectively combine a plurality of first patterns and a plurality of second patterns each corresponding to the first patterns. Respective densities of the first patterns are different from each other. At least one of the second patterns include a plurality of regions where respective coverages are different in a main scanning direction.

### BRIEF DESCRIPTION OF THE DRAWINGS

Exemplary embodiments of the invention will be described in detail based on the following figures, wherein:

FIG. 1 is a block diagram showing the functional configuration of an image processing apparatus of a first exemplary embodiment of the invention;

FIGS. 2A and 2B are views showing an example of a background pattern and hidden character pattern which are stored in a background/hidden character pattern storage portion in the first exemplary embodiment;

FIGS. 3A and 3B are views showing an example of a ground tint pattern image density check chart image (in the case where the in-plane density unevenness is suppressed) in the first exemplary embodiment;

FIGS. 4A and 4B are views showing an example of a ground tint pattern image density check chart image (in the case where an in-plane density unevenness occurs) in the first exemplary embodiment;

FIG. 5 is a conceptual diagram showing the concept of a combination process (ground tint pattern process) in the first exemplary embodiment;

FIGS. 6A to 6E are views showing examples of a combination pattern in the first exemplary embodiment;

FIGS. 7A to 7C are views showing an example of a combination process in the first exemplary embodiment;

FIG. 8 is a view showing relationships between a background combination pattern and the optical density of a print sample (ground tint pattern image) in the first exemplary embodiment;

FIGS. 9A and 9B are views showing an example of an output image in the case where a print sample (ground tint pattern image) is output in the first exemplary embodiment;

FIG. 10 is a flowchart showing the process procedure of a ground tint pattern image production process performed by the image processing apparatus of the first exemplary embodiment;

FIG. 11 is a view illustrating a process of calculating a combination pattern optimum coverage which is performed by a combination pattern optimum coverage calculating portion in the first exemplary embodiment;

FIGS. 12A and 12B are views showing an example of a background combination pattern and hidden character combination pattern which are produced by a combination pattern producing portion in the first exemplary embodiment;

FIG. 13 is a view illustrating the coverage of the background combination pattern which is produced by the combination pattern producing portion in the first exemplary embodiment;

FIGS. 14A to 14C are views showing an example of a background tint pattern which is produced by a ground tint pattern image producing portion in the first exemplary embodiment;

FIGS. 15A to 15C are views showing an example of a hidden character tint pattern which is produced by the ground tint pattern image producing portion in the first exemplary embodiment;

FIG. 16 is a view showing an example of a ground tint pattern image which is produced by the ground tint pattern image producing portion in the first exemplary embodiment;

FIGS. 17A and 17B are views showing a comparative example of a ground tint pattern image in which the in-plane density unevenness occurs, and that in which the in-plane density unevenness is suppressed;

FIG. 18 is a flowchart showing another process procedure (process procedure of a preprocessing) of a ground tint pattern image production process which is performed by the image processing apparatus of the first exemplary embodiment;

FIG. 19 is a flowchart showing another process procedure (process procedure of the ground tint pattern image production process after the preprocessing) of the ground tint pattern image production process which is performed by the image processing apparatus of the first exemplary embodiment;

FIG. 20 is a block diagram showing the functional configuration of an image forming apparatus having an image processing apparatus of a second exemplary embodiment of the invention;

FIG. 21 is a flowchart showing the process procedure of a process of inputting a density optimum number by the user in a preparatory stage in which the ground tint pattern image production process has not been performed in the second exemplary embodiment;

FIG. 22 is a view showing an example of a ground tint pattern image density check chart image (in the case where the in-plane density unevenness is suppressed) in the second exemplary embodiment;

FIG. 23 is a view showing an example of the ground tint pattern image density check chart image (in the case where the in-plane density unevenness occurs) in the second exemplary embodiment;

FIG. 24 is a flowchart showing the process procedure of a ground tint pattern image production process performed by the image processing apparatus of the second exemplary embodiment;

FIG. 25 is a block diagram showing the functional configuration of an image forming apparatus having an image processing apparatus of a third exemplary embodiment of the invention;

FIG. 26 is a flowchart showing the process procedure of a ground tint pattern image production process performed by the image processing apparatus of the third exemplary embodiment;

FIG. 27 is a block diagram showing the functional configuration of an information processing apparatus having an image processing apparatus of a fourth exemplary embodiment of the invention; and

FIG. 28 is a block diagram showing the hardware configuration of the image processing apparatuses of the first to fourth exemplary embodiments of the invention.

### DETAILED DESCRIPTION

Hereinafter, exemplary embodiments which are examples of the invention will be described in detail with reference to the accompanying drawings. In the drawings illustrating the exemplary embodiments, the identical components are denoted by the same reference numerals, and repeated description will be omitted.

### First Exemplary Embodiment

An image processing apparatus of a first exemplary embodiment will be described.

The image processing apparatus produces a plurality of second patterns to be combined with a plurality of first patterns which are related to a ground tint pattern image, and the densities of which are different from each other, respectively, and performs a process of combining the plurality of second patterns with the first patterns corresponding to the second pattern. The image processing apparatus further performs a process of combining together the first patterns which are combined with the second patterns, a process of forming the plurality of first patterns into one pattern, i.e., a process of producing a ground tint pattern image.

For example, assuming that there are a high density pattern, a medium density pattern, and a low density pattern, the plurality of first patterns may be configured by three patterns which are the high density pattern, the medium density pattern, and the low density pattern, or two patterns which are the high density pattern and the low density pattern. These numbers of patterns are provided mere examples, and the numbers are not limited to them. The high density pattern may have large screen line number. The medium density pattern may have medium screen line number. The low density pattern may have small screen line number.

In the first exemplary embodiment, it is assumed that the plurality of first patterns are configured by two patterns of a pattern of a high density (hereinafter, referred to as “high-density pattern”), and a pattern of a low density (hereinafter, referred to as “low-density pattern”).

A high-density pattern is formed as a white portion when an image of the high-density pattern is copied with a copier, and indicates a background portion (hereinafter, referred to as “background pattern”). A low-density pattern remains (appears) when an image of the low-density pattern is copied with a copier, and indicates a hidden character portion (hereinafter, referred to as “hidden character pattern”) which is an example of a latent image portion. The latent image portion is not limited to a hidden character pattern (hidden character portion), and may be, for example, a hidden figure portion (hidden figure pattern) or hidden symbol portion (hidden symbol pattern) which indicates a figure or a symbol. Namely, the latent image portion may be any kind of pattern (such as characters, a figure, or a symbol) which represses or suppresses unauthorized copying and leakage of information of a printed matter (a recording medium on which a print process is performed).

The plurality of second patterns are patterns which are to be combined with the plurality of first patterns (such as a background pattern and a hidden character pattern), respectively, and which indicate a ground tint pattern such as in ‘sakura gami’ (hereinafter, such a pattern is referred to as “combination pattern”).

In the first exemplary embodiment, with respect to at least one of the plurality of second patterns (combination patterns), i.e., a combination pattern which corresponds to the background pattern, a pattern having a plurality of regions where their coverages are different in the main scanning direction in accordance with the output characteristics related to the density of the image forming apparatus is produced.

The output characteristics related to the density mean output characteristics related to the in-plane evenness or the density stability. Specifically, the output characteristics are information related to the output density.

The in-plane evenness means an index for evaluating whether the density in the plane (in the page) is even or not. For example, the case where the in-plane evenness is high or good means a state where the in-plane density is even and the density unevenness is eliminated or suppressed.

The density stability means an index for evaluating whether the density of an output image corresponding to a designated density value is obtained or not. The density stability is varied depending on the environment (the temperature, the humidity, and the like) of the place where the image forming apparatus is located, and deteriorations of components (particularly, an image carrier such as a photosensitive drum, an optical system including an optical scanning system, and the like) constituting the image forming apparatus. For example, the case where the density stability is high or good means a state where the density of an output image matching a designated density value is obtained.

The coverage means an area ratio of an input image in the pulse-surface-area modulation, so-called halftone dot area ratio.

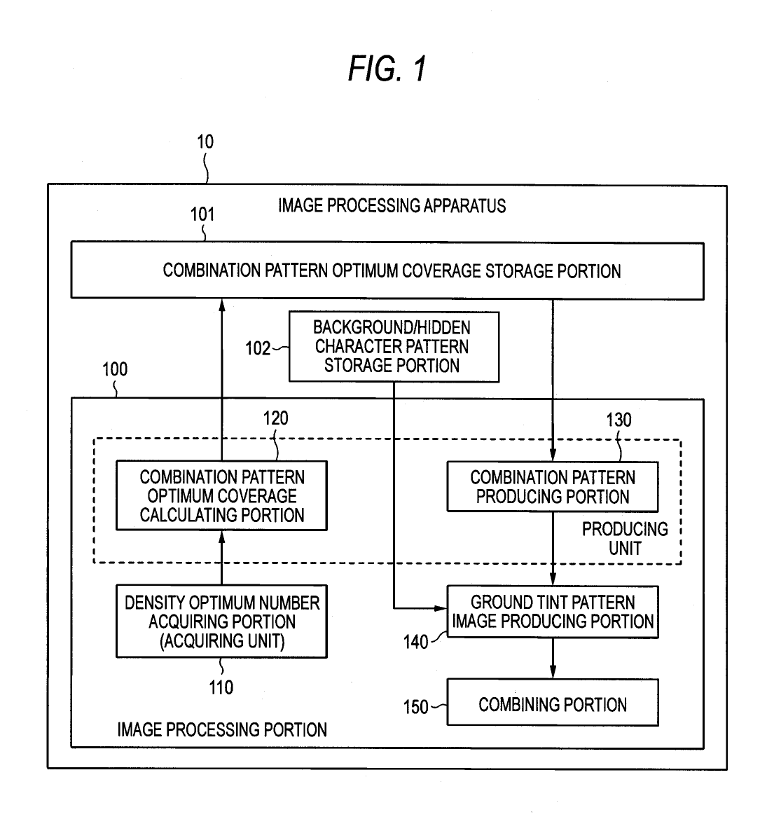

As shown in FIG. 1, the image processing apparatus 10 has an image processing portion 100, a combination pattern optimum coverage storage portion 101, and a background/hidden character pattern storage portion 102.

The image processing portion 100 has a density optimum number acquiring portion 110, a combination pattern optimum coverage calculating portion 120, a combination pattern producing portion 130, a ground tint pattern image producing portion 140, and a combining portion 150.

The density optimum number acquiring portion 110 serves as a function of acquiring module, and acquires the density optimum number which is given through a user interface such as an input/output device or operation panel that is not shown.

The density optimum number indicates information that, in an output image in which ground tint pattern image patches each including a background pattern and a hidden character pattern (latent image pattern) are two-dimensionally formed at a plurality of positions in the main and sub scanning directions, and the plurality of background patterns in the sub scanning direction are formed respectively based on different density parameters, indicates a ground tint pattern image patch in which the difference between the density of the background pattern and that of the latent image pattern is minimum, at each of a plurality of positions in the main scanning direction. The density optimum number will be described later in detail.

The combination pattern optimum coverage calculating portion 120 calculates the optimum coverage of a combination pattern, i.e., the coverage of the optimum combination pattern which is used for optimizing the output characteristics related to the density of the image forming apparatus (hereinafter, referred to as “combination pattern optimum coverage”), based on the density optimum number acquired by the density optimum number acquiring portion 110. The combination pattern optimum coverage calculating portion 120 stores the calculated combination pattern optimum coverage in the combination pattern optimum coverage storage portion 101.

The combination pattern producing portion 130 reads out the combination pattern optimum coverage from the combination pattern optimum coverage storage portion 101, and, based on this, produces a pattern (combination pattern) which is to be combined with the background pattern, and also a pattern (combination pattern) which is to be combined with the hidden character pattern.

Here, a combination pattern which corresponds to the background pattern is defined as “background combination pattern”, and a combination pattern which corresponds to the hidden character pattern is defined as “hidden character combination pattern”.

In the first exemplary embodiment, the combination pattern optimum coverage calculating portion 120 and the combination pattern producing portion 130 serve as a function of a producing unit.

The ground tint pattern image producing portion 140 reads out the background pattern and the hidden character pattern from the background/hidden character pattern storage portion 102, and combines the read out background pattern with the background combination pattern, and the read out hidden character pattern with the hidden character combination pattern.

Here, the result of the combination of the background pattern with the background combination pattern is defined as “background tint pattern”, and the result of the combination of the hidden character pattern with the hidden character combination pattern is defined as “hidden character tint pattern”.

Furthermore, the ground tint pattern image producing portion 140 combines the background tint pattern with the hidden character tint pattern to produce a ground tint pattern image.

The combining portion 150 combines the print data of a received print object with the ground tint pattern image (ground tint pattern image data) which is produced by the ground tint pattern image producing portion 140. The data (image data) obtained by the combination are output to the image forming apparatus which is not shown.

The combination pattern optimum coverage storage portion 101 stores the calculated combination pattern optimum coverage.

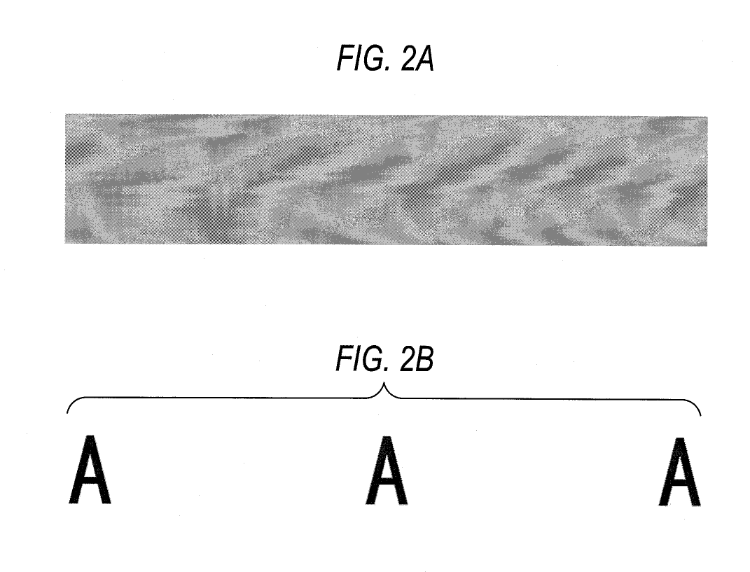

The background/hidden character pattern storage portion 102 stores the background pattern and the hidden character pattern. FIG. 2A shows an example of the background pattern, and FIG. 2B shows an example of the hidden character pattern. In the hidden character pattern shown in FIG. 2B, “A” is exemplified as the hidden character. More specifically, for example, a character string which represses or suppresses unauthorized copying and leakage of information of a printed matter (a recording medium which has undergone a print process), such as “NO COPY” or “COPY PROHIBITED is used.

Next, the density optimum number acquired by the density optimum number acquiring portion 110 will be described.

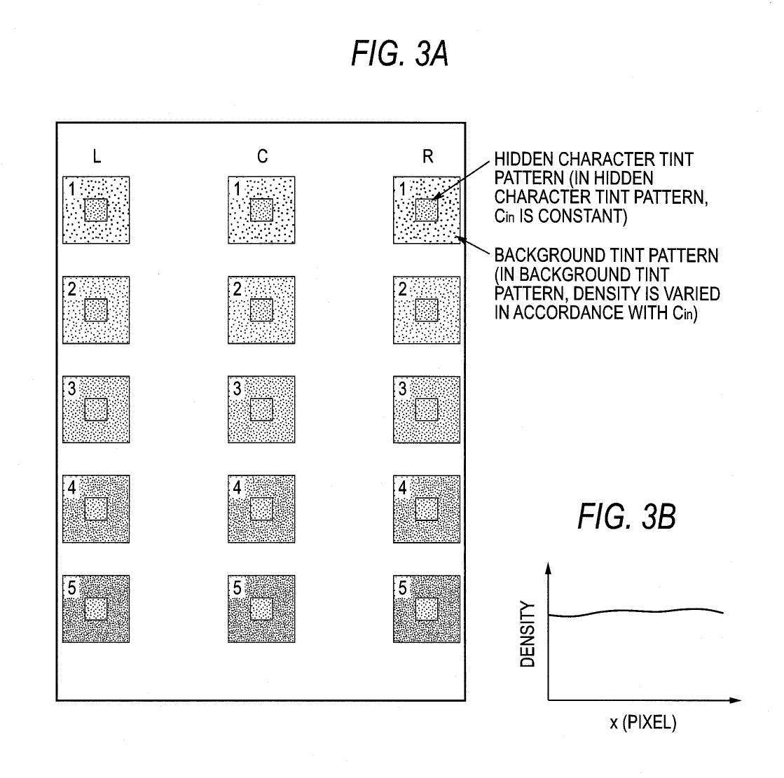

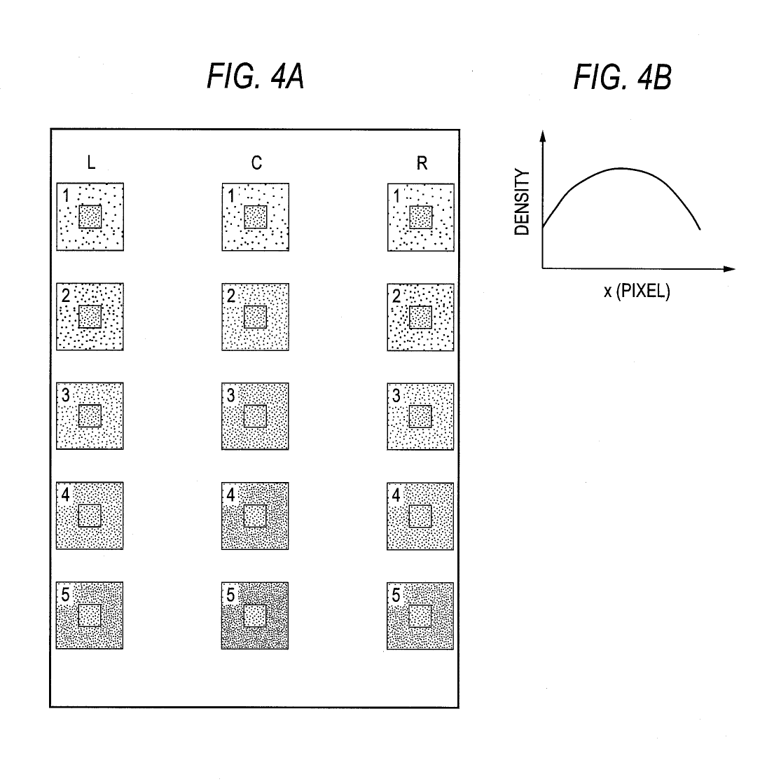

The description will be made exemplifying an image (hereinafter, referred to as “ground tint pattern image density check chart image”) in which, as shown in FIGS. 3A to 4B, for example, fifteen ground tint pattern image patches are two-dimensionally formed in 3 columns by 5 rows in the main and sub scanning directions.

FIGS. 3A and 3B show an example of a result of an output of a ground tint pattern image density check chart image which is performed by an image forming apparatus having a high in-plane evenness, and FIGS. 4A and 4B show an example of a result of an output of a ground tint pattern image density check chart image which is performed by an image forming apparatus having a low in-plane evenness.

In the example shown in FIG. 3A, the relationships between a pixel (x) and the density (Density) of the pixel in the main scanning direction have characteristics such as shown in FIG. 3B. In the characteristics, it is assumed that the output density of any pixel in the main scanning direction is within an allowable range with respect to a predetermined output density. Therefore, the example is an image (ground tint pattern image density check chart image) in which the in-plane evenness is high, or namely the in-plane density unevenness is suppressed.

In the example shown in FIG. 4A, by contrast, the relationships between a pixel (x) and the density (Density) of the pixel in the main scanning direction have characteristics such as shown in FIG. 4B. In the characteristics, the output densities of pixels of both end portions in the main scanning direction are not within the allowable range with respect to the predetermined output density. Therefore, the example is an image (ground tint pattern image density check chart image) in which the in-plane evenness is low, or namely the in-plane density unevenness occurs.

In both the examples of FIGS. 3A and 4A, in the ground tint pattern image density check chart, three ground tint pattern image patches arranged in the main scanning direction are formed as one group, five groups are formed in the sub scanning direction, and the background tint patterns (background dot patterns) of ground tint pattern image patches of each one of the different groups in the sub scanning direction are formed based on different density parameters, respectively.

In the fifteen ground tint pattern image patches, the same number is allocated to ground tint pattern image patches belonging to the identical group (ground tint pattern image patches on the identical line), and different numbers are allocated to ground tint pattern image patches belonging to different groups.

In FIGS. 3A and 4A, namely, 1, 2, 3, 4, and 5 are numbers which are allocated to the ground tint pattern image patches, and which are information indicating the ground tint pattern image patches. The characters L, C, and R indicate the positions of the left portion (Left), the center portion (Center), and the right portion (Right) in the main scanning direction, respectively. Here, ground tint pattern image patches which are located at the position of the left portion L, and to which numbers 1, 2, 3, 4, and 5 are allocated are indicated by L1, L2, L3, L4, and L5, respectively, and those which are located at the positions of the center portion C and the right portion R are similarly indicated by C1, C2, C3, C4, and C5, and R1, R2, R3, R4, and R5, respectively.

In the examples shown in FIGS. 3A and 4A, ground tint pattern image patches to which the same number (one of the numbers 1, 2, 3, 4, and 5) is allocated belong to the identical group.

In the examples shown in FIGS. 3A and 4A, all the hidden character tint patterns (hidden character dot patterns) of the ground tint pattern image patches (fifteen ground tint pattern image patches L1 to L5, C1 to C5, and R1 to R5) of all the groups are formed by the same density parameter.

By contrast, background tint patterns of ground tint pattern image patches (those to which the same number is allocated) of the identical group are formed by the same density parameter, but background tint patterns of ground tint pattern image patches of different groups in the sub scanning direction are formed by different density parameters.

In the example, for example, the background tint patterns of the ground tint pattern image patches L1, C1, R1 are set so as to have the same density (the same density parameter). Moreover, the background tint patterns are set so that, as the value of the number allocated to the corresponding ground tint pattern image patch is larger, the density is larger (the value of the density parameter is larger). In the case where the five ground tint pattern image patches located in the left portion L are considered, for example, the density parameters of the background tint patterns have the relationships of “L1<L2<L3<L4<L5”.

Under the preconditions, among the fifteen ground tint pattern image patches in 3 columns by 5 rows, the ground tint pattern image patch in which the difference between the density of the background tint pattern and that of the hidden character tint pattern is minimum is selected in each column. The information indicating the ground tint pattern image patch which is selected in each column, i.e., the number is the density optimum number. In the example, three density optimum numbers are selected.

As the density optimum number in the examples shown in FIGS. 3A and 4A, specifically, one number is selected at each of the positions (columns) of the left portion L, the center portion C, and the right portion R. In the example shown in FIG. 3A, the number of 3 is selected in the three columns of the left portion L, the center portion C, and the right portion R (L3, C3, and R3 are selected). In the example shown in FIG. 4A, by contrast, the number of 5 is selected in the two columns of the left portion L and the right portion R (L5 and R5 are selected), and the number of 3 is selected in the column of the center portion C (C3 is selected).

In the selection of the density optimum number in this case, the above-described density optimum number is selected while the user views an output image (printed matter on which the ground tint pattern image density check chart image is printed) in which, for example, the fifteen ground tint pattern image patches and the numbers allocated to the ground tint pattern image patches are formed. Alternatively, an image reading apparatus such as a scanner may scan an output image (printed matter), and the image processing apparatus may select the above-described density optimum number based on the result of the scan.

The technique of printing a ground tint pattern is configured by the following three factors 1 to 3.

(1) High-density pattern. A high-density pattern is formed as a white portion as a result of a copy process.

(2) Low-density pattern. A low-density pattern remains as a result of a copy process.

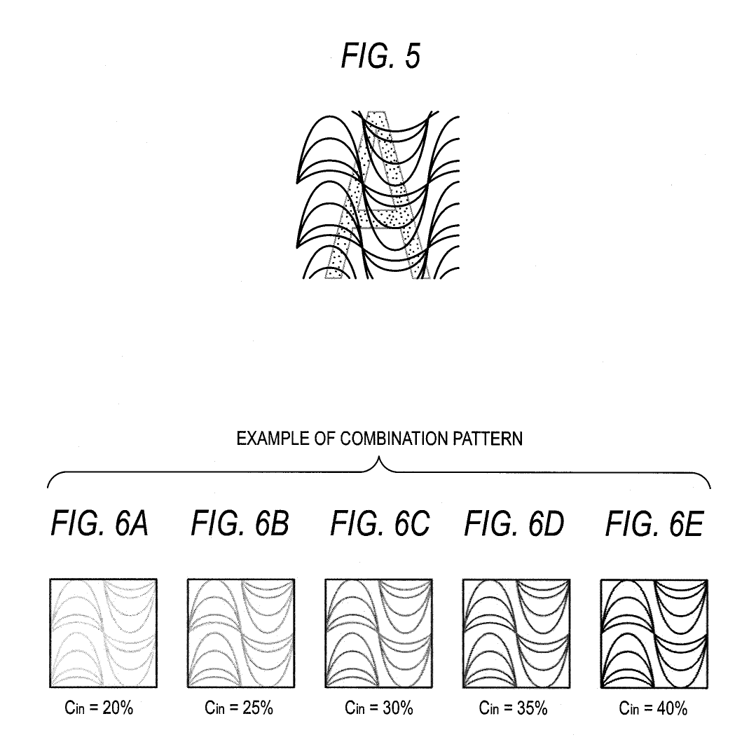

(3) Combination process (ground tint pattern processing). The density difference between patterns is made less prominent by forming a ground tint pattern such as in ‘sakura gami’. As a result of the combination process (ground tint pattern process), for example, density differences between a background pattern as a high-density pattern and a hidden character pattern as a low-density pattern are made less prominent as shown in FIG. 5.

Here, conditions for obtaining a high image quality in the print image quality and the copy image quality will be described.

With respect to the print image quality, there are following conditions A and B.

(A) The pattern density of the background is lowered. This is performed in order that influences of the density stability (density variation) and in-plane evenness (in-plane density unevenness) of means (image forming unit=print engine) for performing image formation in the image forming apparatus are suppressed to the minimum degree.

(B) The combination process is performed on the hidden character pattern (hidden character portion) and the background pattern (background portion). This is performed in order that the pattern density step difference between the above-described two patterns (the hidden character pattern and the background pattern) is made less prominent.

By contrast, with the copy image quality, there are following conditions C and D.

(C) The pattern density of the background is heightened. This is performed in order that the background easily disappears as a result of a copy process.

(D) The combination process is performed only on the background pattern (background portion). This is performed in order that the hidden characters easily remain as a result of a copy process.

As described above, the print image quality and the copy image quality are in a trade-off relationship.

In the first exemplary embodiment, therefore, a high-density pattern (for example, error diffusion) is used as the background pattern in order to ensure the copy image quality. Furthermore, in order to ensure the copy image quality, a function of suppressing (or absorbing) influences of the density stability (density variation) and in-plane evenness (in-plane density unevenness) is added to “combination process (ground tint pattern process)” in addition to a function of making the density step difference between two patterns (the hidden character pattern and the background pattern) less prominent.

For example, combination patterns shown in FIGS. 6A to 6E are prepared. FIGS. 6A to 6E show combination patterns in which their coverages (Cin, indicated as Cᵢₙ in the figures (also in other figures), the same shall apply hereinafter) are 20%, 25%, 30%, 35%, and 40%, respectively. The combination patterns are grown by changing the coverage as shown in FIGS. 6A to 6E.

In the above-described fifteen ground tint pattern image patches shown in FIGS. 3A to 4B, the hidden character combination patterns of the hidden character tint patterns of the ground tint pattern image patches to which numbers 1 to 5 are allocated are those to which a specific one (for example, the combination pattern (Cin=30%) shown in FIG. 6C) of the combination patterns shown in FIGS. 6A to 6E is applied.

By contrast, the background combination patterns of the background tint patterns of the ground tint pattern image patches to which numbers 1 to 5 are allocated are those to which the combination pattern (Cin=40%) shown in FIG. 6E, the combination pattern (Cin=35%) shown in FIG. 6D, the combination pattern (Cin=30%) shown in FIG. 6C, the combination pattern (Cin=25%) shown in FIG. 6B, and the combination pattern (Cin=20%) shown in FIG. 6A are applied correspondingly with the background tint patterns of the ground tint pattern image patches corresponding to numbers 1, 2, 3, 4, and 5, respectively.

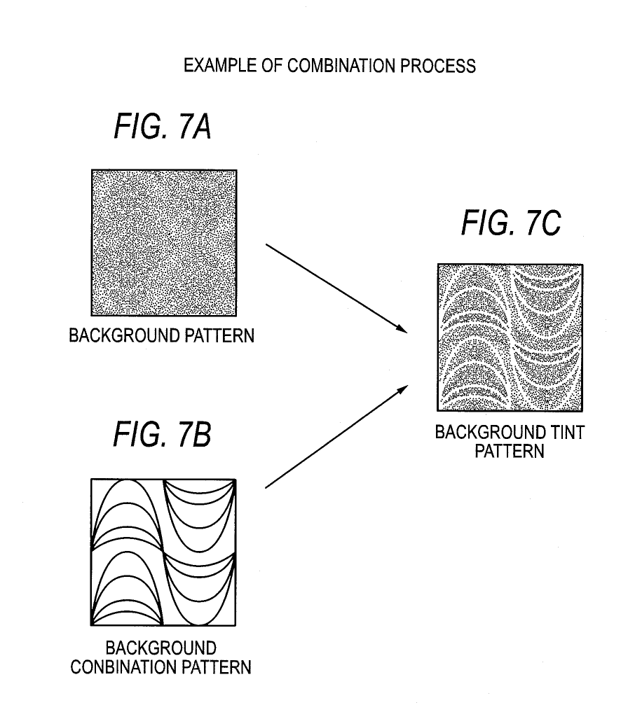

FIGS. 7A to 7C show an example of a result (background tint pattern) which is a result of the process (ground tint pattern process) of combining such a background combination pattern with a background pattern. The combination process in this case is a process in which a binary background combination pattern (see FIG. 7B) is simply subtracted from a binary background pattern (binary background dot pattern (see FIG. 7A)). When such a combination process is performed, a background tint pattern (a pattern after the combination process, i.e., a background dot pattern) such as shown in FIG. 7C is obtained.

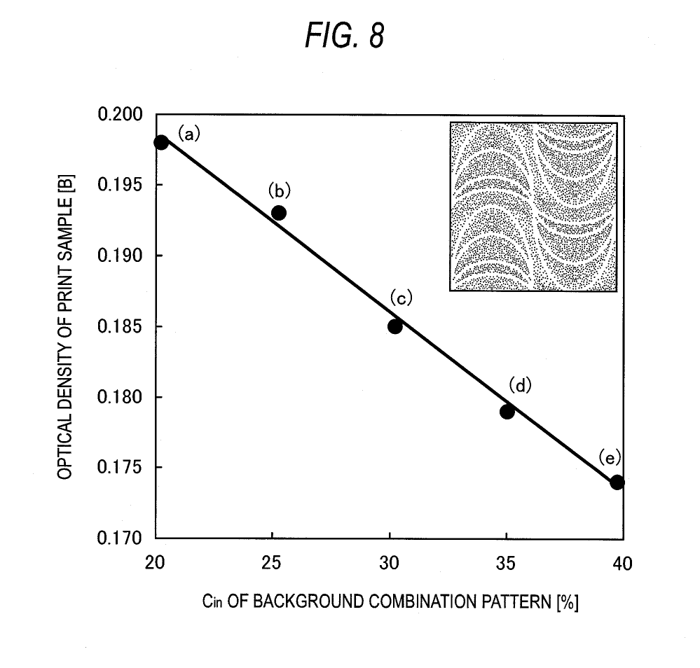

FIG. 8 shows an example of relationships between, when a binary background combination pattern (see FIG. 7B) is set as the combination patterns shown in FIGS. 6A to 6E, the print density (optical density of a print sample: unit of [%]) in the case where a background tint pattern (a pattern after the combination process, i.e., a background dot pattern) which is a result of a process of combining the binary background combination patterns with a binary background pattern (see FIG. 7A), and the coverage (Cin: unit of [B]) of the background combination pattern.

In FIG. 8, (a) to (e) correspond to the background combination patterns of FIGS. 6A to 6E, respectively.

As shown in FIG. 8, the coverage (Cin) of the background combination pattern and the print density (optical density of a print sample) are in an inverse proportional relationship to each other. For example, points (a) and (e) in FIG. 8 are considered. In the case where the coverage is 40%, for example, the density of a pattern which is printed on a recording medium is higher as compared with the case where the coverage is 20%, and hence the density (optical density) corresponding to the light quantity of reflected light from the pattern is low. As the value of the coverage is larger, therefore, the optical density of a print sample is lower.

In the first exemplary embodiment, the density stability (density variation) and in-plane evenness (in-plane density unevenness), i.e., the density variation of the above-described image forming unit (print engine) are corrected by using the relationship. This means that the output characteristics related to the density of the image forming apparatus is corrected to predetermined output characteristics related to a density.

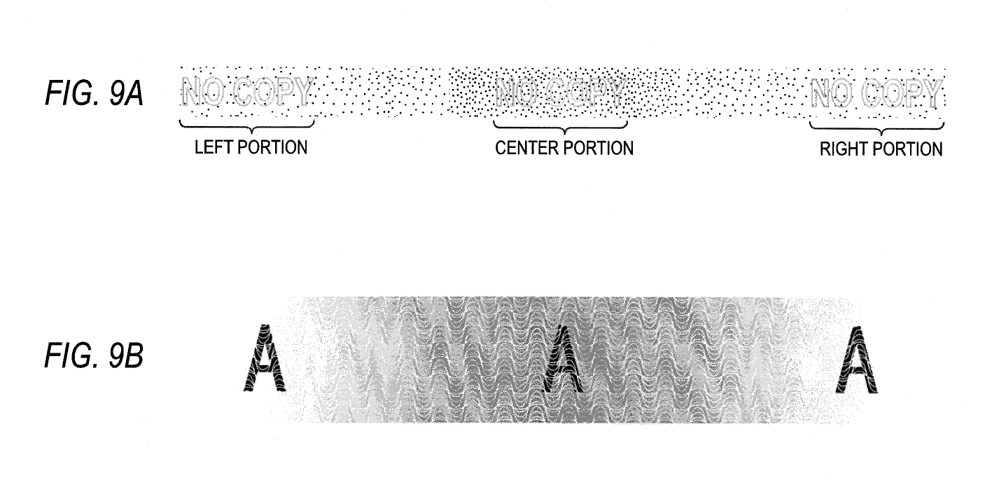

FIGS. 9A and 9B show an example of an output image (a print result on a recording medium) in the case where a print sample (ground tint pattern image) is output by an image forming unit (print engine) in which the in-plane evenness is low.

FIGS. 9A and 9B show an output image in which in-plane density unevenness occurs due to a print process performed by an image forming unit (print engine) in which the in-plane evenness is low.

In the example shown in FIG. 9A, for example, hidden characters “NO COPY” are sufficiently hidden in a center portion (in the vicinity of the center of the sheet surface), but the evenness of the background is not attained in the right and left portions and hidden characters “NO COPY” appear. This is caused because the high-density pattern used in the background, and the low-density pattern used in the hidden characters are different in sensitivity with respect to the in-plane evenness of the image forming unit (print engine).

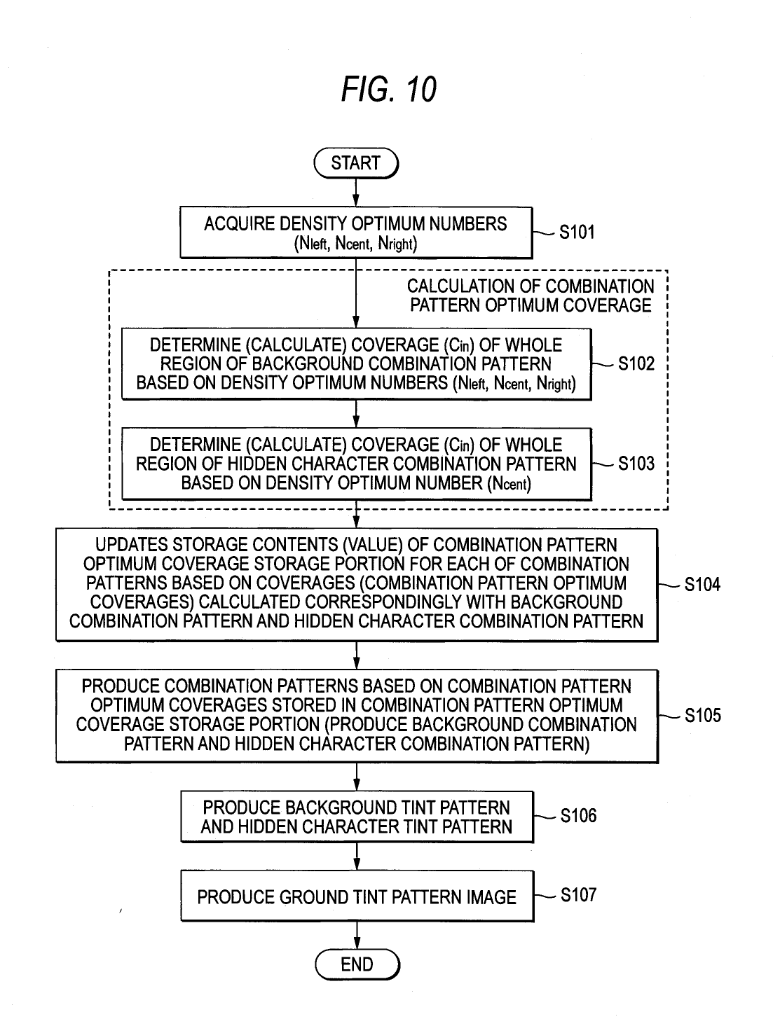

Next, a ground tint pattern image production process performed by the image processing apparatus will be described with reference to FIG. 10.

First, preconditions will be described. It is assumed that a ground tint pattern image density check chart image which is a print object, and which is printed by the image forming apparatus has the contents (output image in which the in-plane density unevenness occurs) shown in FIG. 4A, and that a result of an output of the ground tint pattern image (print sample) which is produced by the image forming apparatus under the characteristics shown in FIG. 4B has the contents (output image in which the in-plane density unevenness occurs) shown in FIG. 9B. Furthermore, it is assumed that the user visually selects the ground tint pattern image patches L5, C3, R5 as a ground tint pattern image patch in which the density difference between the background tint pattern and the hidden character tint pattern is minimum.

Under the preconditions, the user operates an inputting portion of the user interface (not shown) such as the operation panel of the image processing apparatus 10 to input corresponding density optimum numbers in setting columns of “N_{left}=”, “N_{cent}=”, and “N_{right}=” of an input screen which is displayed on a displaying portion of the operation panel, and which is used for inputting density optimum numbers. N_{left} indicates the density optimum number corresponding to the ground tint pattern image patch which is placed in the left portion L.

N_{cent} indicates the density optimum number corresponding to the ground tint pattern image patch which is placed in the center portion C.
N_{right} indicates the density optimum number corresponding to the ground tint pattern image patch which is placed in the right portion R.

The user interface outputs N_{left}=5, N_{cent}=3, and N_{right}=5 as the density optimum numbers to the density optimum number acquiring portion 110.

When the density optimum number acquiring portion 110 receives the density optimum numbers from the user interface (step S101), the portion outputs the density optimum numbers (N_{left}=5, N_{cent}=3, and N_{right}=5) to the combination pattern optimum coverage calculating portion 120.

The combination pattern optimum coverage calculating portion 120 calculates the combination pattern optimum coverage (the optimum coverage of the combination pattern) based on the received density optimum numbers (N_{left}=5, N_{cent}=3, and N_{right}=5).

Namely, the combination pattern optimum coverage calculating portion 120 calculates the coverage (Cin) of the whole region of the background combination pattern based on the received density optimum numbers “N_{left}=5”, “N_{cent}=³”, and “N_{right}=5” (step S102), and further calculates the coverage (Cin) of the whole region of the hidden character combination pattern based on one of the received density optimum numbers, such as “N_{cent}=3” (step S103).

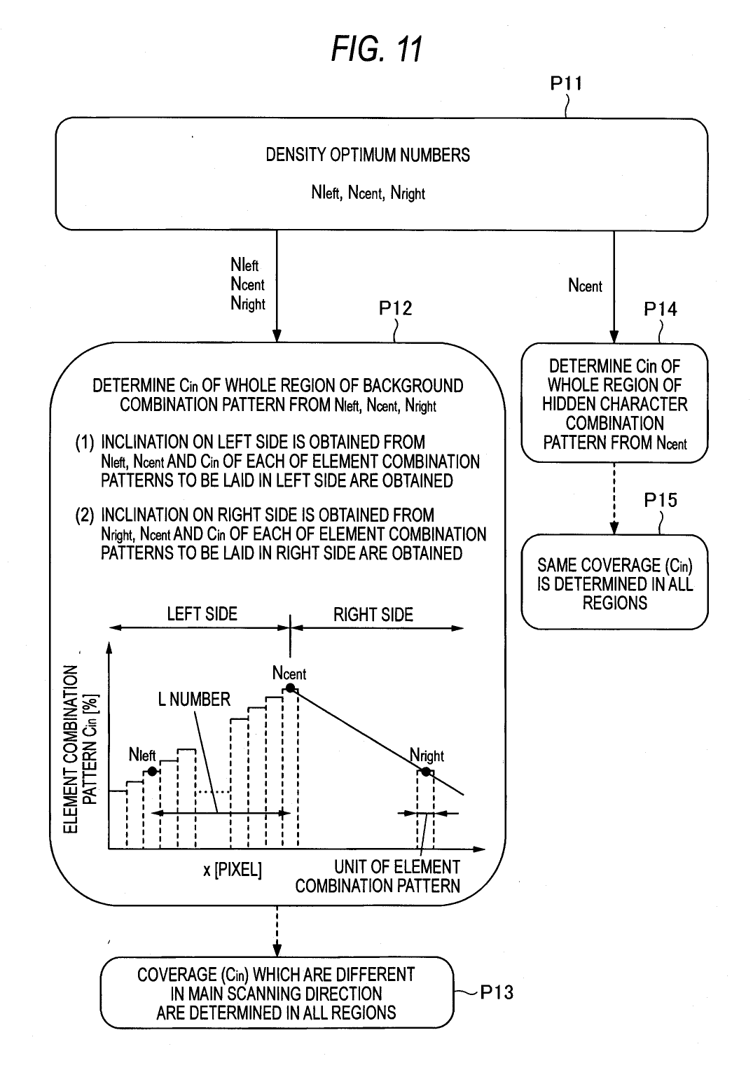

Here, the process of calculating the combination pattern optimum coverage by the combination pattern optimum coverage calculating portion 120 will be described with reference to FIG. 11.

As shown in FIG. 11, when receiving the density optimum numbers of “N_{left}=5”, “N_{cent}=3”, and “N_{right}=5” (see P11 of FIG. 11), the combination pattern optimum coverage calculating portion 120 determines the coverage (Cin) of the whole region of the background combination pattern (combination pattern for “background dot pattern”) based on “N_{left}=5”, “N_{cent}=3”, and “N_{right}=5”. The coverage (Cin) of the whole region is obtained in following (1) and (2) (see P12 of FIG. 11).

A background dot pattern is configured by combination patterns which function as a plurality of elements. In the first exemplary embodiment, the unit of a combination pattern functioning as an element is the region (range) in the main scanning direction of a combination pattern such as shown in FIGS. 6A to 6E. Here, a combination pattern functioning as an element is defined as an element combination pattern.

The combination pattern optimum coverage calculating portion 120 previously knows the relationships between the density optimum number and the coverage (Cin). The density optimum numbers 1, 2, 3, 4, and 5 correspond to the coverages (Cin) of 40%, 35%, 30%, 25%, and 20%, respectively.

(1) The inclination of the left side is obtained based on “N_{left}=5” and “N_{cent}=3”, and the coverages (Cin) of element combination patterns which are to be laid in the left side are obtained.

(2) The inclination of the right side is obtained based on “N_{right}=5” and “N_{cent}=3”, and the coverages (Cin) of element combination patterns which are to be laid in the right side are obtained.

The calculation process of (1) above will be described in more detail. From the density optimum numbers, the combination pattern optimum coverage calculating portion 120 may know the coverages (Cin) of the background combination patterns corresponding to the numbers, and hence determines which one of the coverages (Cin) is optimum at the points of the left portion L, the center portion C, and the right portion R.

Next, from the determined coverages (Cin) of the three points, the combination pattern optimum coverage calculating portion 120 obtains the values of steps the coverages (Cin) by which the element combination patterns are to be laid in the gaps.

For example, a case will be considered where the coverage of the patch (Left patch) of a background combination pattern which is placed in the left portion L is indicated as C_{left}, that of the patch (Center patch) of a background combination pattern which is placed in the center portion C is indicated as C_{cent}, the number of element combination pattern units that are laid between Left patch and Center patch is indicated as L, and the coverage of a reference background combination pattern is indicated as Cₒ. In this case, the coverage Cₙ of an n-th element combination pattern is expressed by following Exp. (1):

Cₙ={(C_{cent}−C_{left}/L}×n+C₀ (Exp. 1)

Then, the calculation process of (2) above will be described in more detail. Similarly with the case of the above-described calculation process of (1) above, a case will be considered where the coverage of the patch (Right patch) of a background combination pattern which is placed in the right portion R is indicated as C_{right}, that of the patch (Center patch) of a background combination pattern which is placed in the center portion C is indicated as C_{cent}, the number of element combination pattern units that are laid between Right patch and Center patch is indicated as L, and the coverage of a reference background combination pattern is indicated as C₀. In this case, the coverage Cₙ of an n-th element combination pattern is expressed by following Exp. (2):

Cₙ={(C_{cent}−C_{right}/L}×n+C₀ (Exp. 2)

Then, the combination pattern optimum coverage calculating portion 120 calculates the inclinations of the right and left sides with respect to Center patch, to obtain coverages of the element combination patterns. As a result, different coverages (Cin) in the main scanning direction are determined in all the regions (see P13 of FIG. 11).

In the whole region (whole surface) of the background combination pattern (combination pattern for “background dot pattern”), therefore, there are a plurality of element combination patterns in which the coverages (Cin) are different in the main scanning direction. Namely, there are a plurality of regions (element combination patterns) in which the coverages (Cin) are different in the main scanning direction.

A specific example of the coverages (Cin) which are different in the main scanning direction will be described. It is assumed that, in P13 of FIG. 11, both Left patch of “N_{left}=5” and Right patch of “N_{right}=5” have the coverage of Cin=20%, and Center patch of “N_{cent}=3” has the coverage of Cin=30%.

Under the preconditions, the coverage Cin of the element combination patterns which are laid between Left patch and Center patch, and that of the element combination patterns which are laid between Right patch and Center patch are, for example, larger than 20% and less than 30%.

The coverage Cin of the element combination patterns which are laid on the left side of Left patch, and that of the element combination patterns which are laid on the right side of Right patch are, for example, less than 20%.

On the other hand, the combination pattern optimum coverage calculating portion 120 determines the coverage Cin of the whole region of the hidden character combination pattern (combination pattern for “hidden character dot pattern”) based on one of the density optimum numbers of “N_{left}=5”, “N_{cent}=3”, and “N_{right}=5” (see P14 of FIG. 11).

Namely, with respect to the hidden character combination pattern (combination pattern for “hidden character dot pattern”), the combination pattern optimum coverage calculating portion 120 does not change the coverage (Cin) of (each element combination pattern of) the hidden character combination pattern in the plane, employs the hidden character combination patterns of one of three points or the left portion L, the center portion C, and the right portion R, for example, the hidden character combination pattern of the center portion C, and determines it as the coverage (C_{cent}) of the hidden character combination pattern which is identical in the whole region (see P15 of FIG. 11).

Therefore, the whole region (whole surface) of the hidden character combination pattern (combination pattern for “hidden character dot pattern”) is configured by (element combination patterns of) the hidden character combination pattern having the same coverage (C_{cent}).

The above-described density correction due to a combination pattern is performed only on the background pattern, because it is easy to handle correction of only the background portion (high-density pattern) which is weak in the density stability (density variation) and in-plane evenness (in-plane density unevenness).

Referring again to FIG. 10, the description will be made. Based on the coverages (combination pattern optimum coverages) which are calculated correspondingly with the background combination pattern and the hidden character combination pattern as described above, the combination pattern optimum coverage calculating portion 120 updates the storage contents (value of the coverage) of the combination pattern optimum coverage storage portion 101 for each of the combination patterns (step S104).

Next, the combination pattern producing portion 130 reads out the combination pattern optimum coverages which correspond respectively to the background combination pattern and the hidden character combination pattern, from the combination pattern optimum coverage storage portion 101, and produces combination patterns for the background combination pattern and the hidden character combination pattern based on the coverages (step S105).

Specifically, the combination pattern producing portion 130 produces the background combination pattern which is to be combined with the background pattern, based on the combination pattern optimum coverage corresponding to the background combination pattern, and produces the hidden character combination pattern which is to be combined with the hidden character pattern, based on the combination pattern optimum coverage corresponding to the hidden character combination pattern.

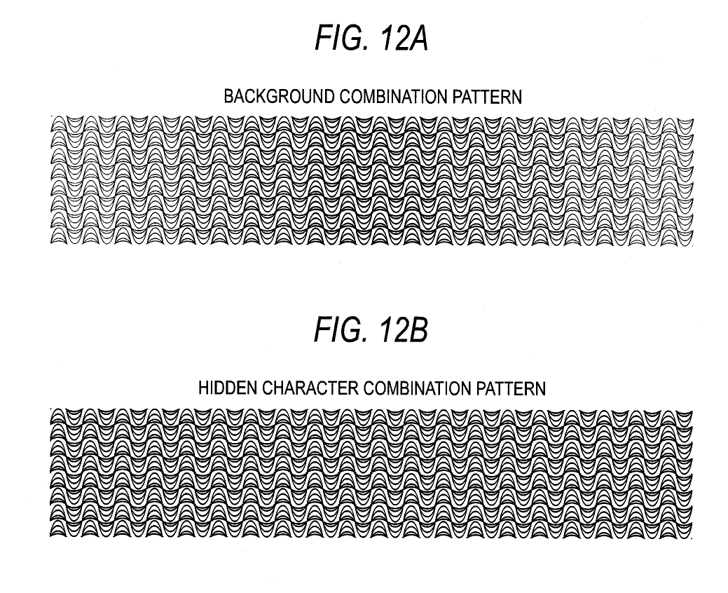

FIG. 12A shows an example of the background combination pattern, and FIG. 12B shows an example of the hidden character combination pattern.

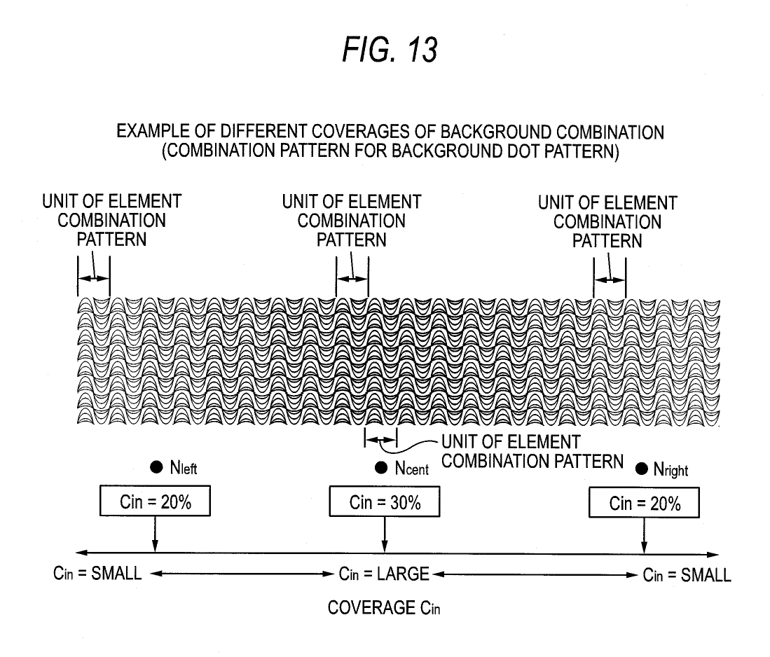

The background combination pattern (combination pattern for “background dot pattern”) shown in FIG. 12A is a pattern which, as shown in FIG. 13, has a plurality of regions (element combination patterns) that are different in coverage in the main scanning direction. In this case, the minimum unit of the region (range) in the main scanning direction related to the plurality of regions, i.e., the minimum unit of the element combination patterns (combination patterns functioning as elements) is the unit of the element combination pattern shown in FIG. 13. Namely, as described above, the region (range) in the main scanning direction of a combination pattern such as shown in FIGS. 6A to 6E is the unit of the element combination patterns (combination patterns functioning as elements).

In the example shown in FIG. 13, as described above, Left patch of “N_{left}=5” and Right patch of “N_{right}=5” have the coverage of Cin=20%, and Center patch of “N_{cent}=3” has the coverage of Cin=30%. Therefore, the coverage Cin of the element combination patterns between Left patch and Center patch, and that of the element combination patterns between Right patch and Center patch are, for example, larger than 20% and less than 30%.

The coverage Cin of the element combination patterns which are on the left side of Left patch, and that of the element combination patterns which are on the right side of Right patch are, for example, less than 20%.

Referring again to FIG. 10, the description will be made. When the background combination pattern and the hidden character combination pattern are produced as described above, the ground tint pattern image producing portion 140 reads out the background pattern (see FIG. 2A) and the hidden character pattern (see FIG. 2B) from the background/hidden character pattern storage portion 102, combines the read out background pattern with the background combination pattern (see FIG. 12A) to produce the background tint pattern, and combines the read out hidden character pattern with the hidden character combination pattern (see FIG. 12B) to produce the hidden character tint pattern (step S106).

Moreover, the ground tint pattern image producing portion 140 combines the background tint pattern with the hidden character tint pattern to produce the ground tint pattern image (step S107).

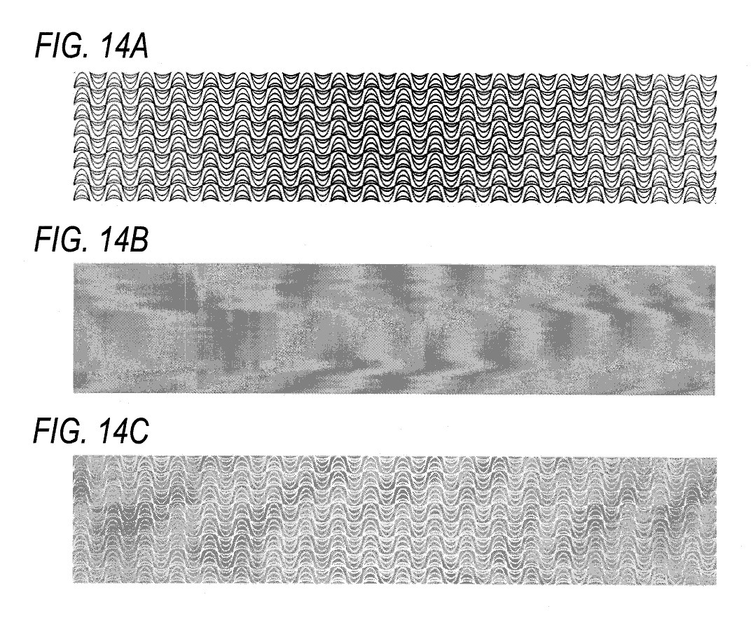

As shown in FIGS. 14A to 14C, for example, the ground tint pattern image producing portion 140 combines a background tint pattern shown in FIG. 14A (same as that of the example of FIG. 12A) with a background pattern shown in FIG. 14B (same as that of the example of FIG. 2A) to produce a background tint pattern shown in FIG. 14C.

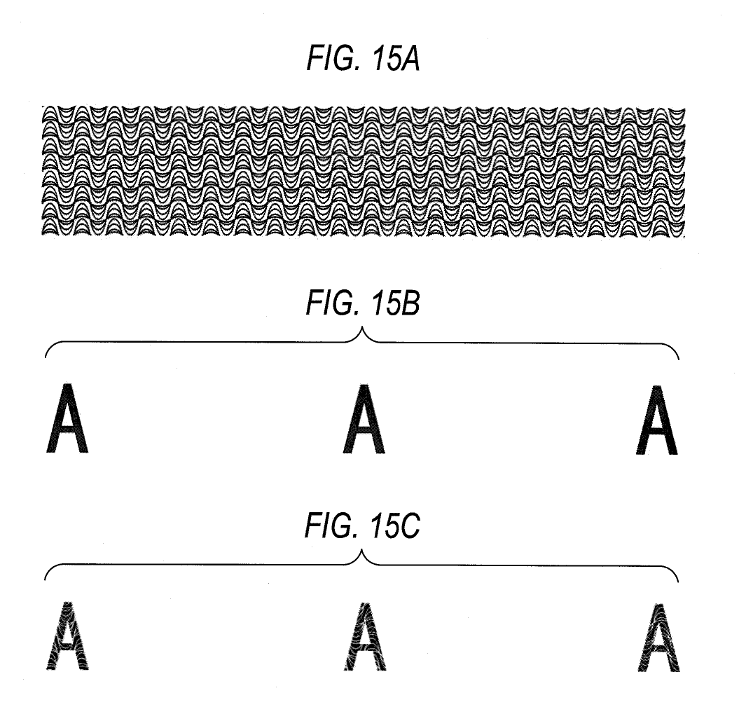

As shown in FIGS. 15A to 15C, moreover, the ground tint pattern image producing portion 140 combines a hidden character combination pattern shown in FIG. 15A (same as that of the example of FIG. 12B) with a hidden character pattern shown in FIG. 15B (same as that of the example of FIG. 2B) to produce a hidden character tint pattern shown in FIG. 15C.

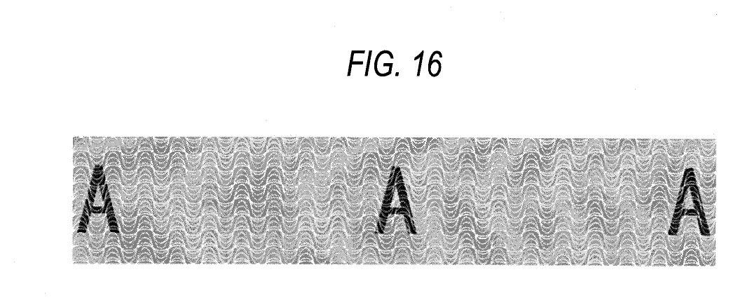

Then, the ground tint pattern image producing portion 140 combines the background tint pattern shown in FIG. 14C which is produced as described above, with the hidden character tint pattern shown in FIG. 15C to produce a ground tint pattern image shown in FIG. 16.

The ground tint pattern image which is produced as described above is combined with the print data of the print object by the combining portion 150. Thereafter, the combined data (image data) are output to the image forming apparatus which is not shown.

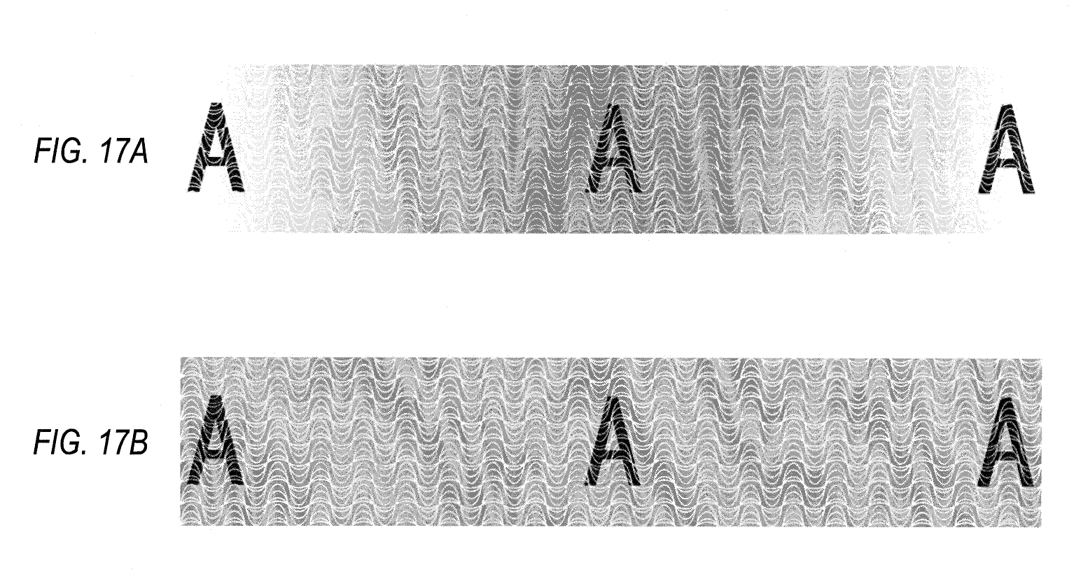

As described above, in the case where a ground tint pattern image is print-output as a result of an imaging process (ground tint pattern image production process) by an image processing apparatus which does not have the configuration of the first exemplary embodiment, an output result (same as that of the example of FIG. 9B) of the ground tint pattern image in which the in-plane density unevenness occurs as shown in FIG. 17A is obtained. By contrast, in the case where a ground tint pattern image is print-output as a result of an imaging process (ground tint pattern image production process) by an image processing apparatus which has the configuration of the first exemplary embodiment, i.e., the image processing apparatus 10, an output result (same as that of the example of FIG. 16) of the ground tint pattern image in which the in-plane density unevenness is eliminated or suppressed as shown in FIG. 17B as compared with the case of the example shown FIG. 17A is obtained.

Next, an application example of the first exemplary embodiment will be described.

In the above-described ground tint pattern image production process shown in FIG. 10, the processes ranging from the acquiring of the density optimum number to the production of the ground tint pattern image have been described as a series of processes. The processes are not limited to this, and may be performed in the following manner.

Namely, the processes may be split into a preprocessing in which the processes ranging from the acquiring of the density optimum number to the calculation of the combination pattern optimum coverage are performed, and a ground tint pattern image production process in which the productions of combination patterns (the background combination pattern and the hidden character combination pattern) and the production of the ground tint pattern image are performed.

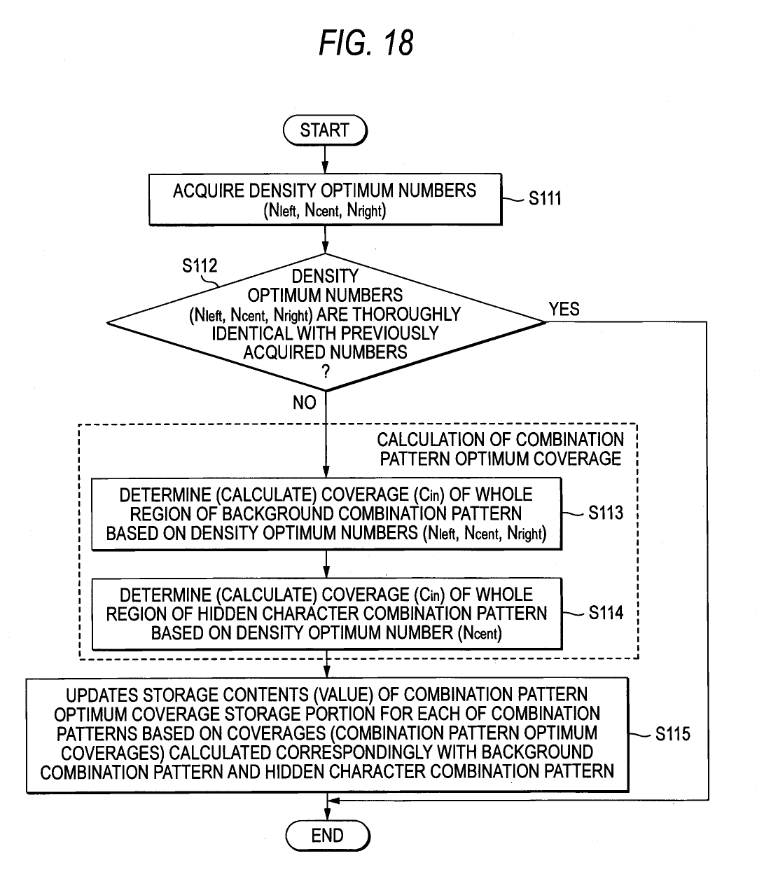

First, the preprocessing will be described with reference to FIG. 18.

As shown in FIG. 18, when the density optimum number acquiring portion 110 acquires the density optimum numbers from a user interface which is not shown (step S111), the portion determines whether the currently acquired density optimum numbers (N_{left}, N_{cent}, N_{right}) are thoroughly identical with the previously acquired density optimum numbers or not (step S112).

If it is determined in step S112 that the currently acquired density optimum numbers are not thoroughly identical with the previously acquired density optimum numbers (at least one of the density optimum numbers is different), the currently acquired density optimum numbers (N_{left}, N_{cent}, N_{right}) are output to the combination pattern optimum coverage calculating portion 120. By contrast, if it is determined that the density optimum numbers are thoroughly identical, the preprocessing is ended.

The combination pattern optimum coverage calculating portion 120 which receives the density optimum numbers from the density optimum number acquiring portion 110 performs processes which are identical with above described steps S102 to S104 (steps S113 to S115), and then terminates the processes.

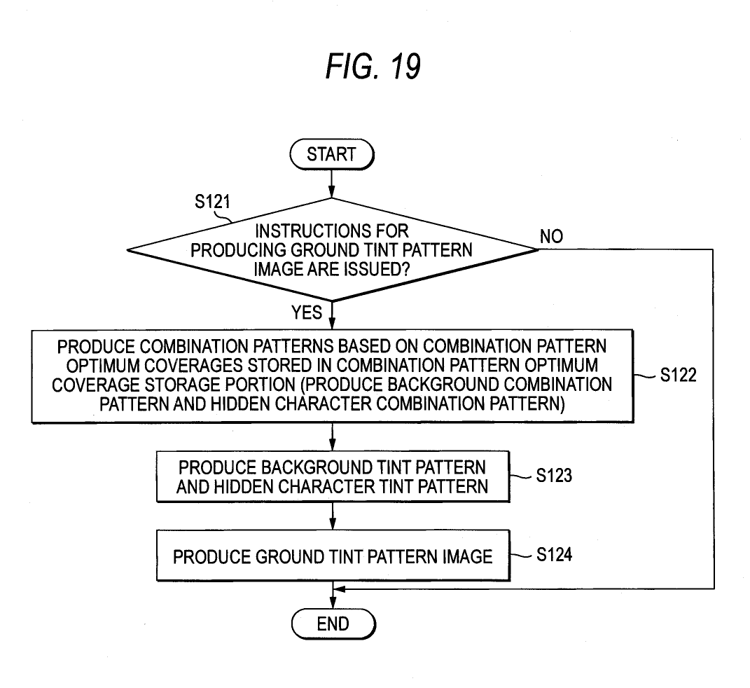

Next, the ground tint pattern image production process which is performed after the preprocessing will be described with reference to FIG. 19.

As shown in FIG. 19, the image processing portion 100 determines whether instructions for producing the ground tint pattern image are issued or not (step S121). If it is determined that instructions for producing a ground tint pattern image are issued, the portion instructs the combination pattern producing portion 130 so as to produce a combination pattern, and, if it is determined that instructions for producing a ground tint pattern image are not issued, the process is ended.

With respect to instructions for producing the ground tint pattern image, for example, there are cases where the user issues the instructions for each of the print data of the print object which is received by the combining portion 150, and where the administrator previously instructs (sets) so that the instructions are applied to print data of all print objects.

In the former case, the image processing portion 100 determines whether instructions for producing a ground tint pattern image are input through the user interface (not shown) or not, thereby performing determination whether instructions for producing a ground tint pattern image are issued or not.

In the latter case, the image processing portion 100 determines whether or not information of instructions for producing a ground tint pattern image is stored in a storage portion (or a storage area) which is to hold information of instructions for producing a ground tint pattern image that is input through the user interface which is not shown, thereby performing determination whether instructions for producing a ground tint pattern image are issued or not.

The combination pattern producing portion 130 which is instructed so as to produce a combination pattern performs a process which is similar to that of above-described step S105, to produce combination patterns (step S122), and outputs a result (a background combination pattern and a hidden character combination pattern) of the process to the ground tint pattern image producing portion 140.

Based on the result (the background combination pattern and the hidden character combination pattern) of the process from the combination pattern producing portion 130, then, the ground tint pattern image producing portion 140 performs a process which is similar to that of above-described step S106, to produce a background tint pattern and a hidden character tint pattern (step S123), and performs a process which is similar to that of above-described step S107, to produce a ground tint pattern image (step S124).

In the above-described application example of the first exemplary embodiment, each time when density optimum numbers are acquired, combination pattern optimum coverages corresponding to a background combination pattern and a hidden character combination pattern are calculated based on the density optimum numbers, and the background combination pattern and the hidden character combination pattern are produced based on the calculated combination pattern optimum coverages. However, the example is not limited to this, and may be configured in the following manner.

In the case where the image forming unit (print engine) of the image forming apparatus has no difference depending on unit, and the changing manner of the density output characteristics related to the image forming unit is in a predetermined range, a background combination pattern and hidden character combination pattern which are obtained by first and second methods described below may be employed.

In the first method, during production or shipment of the image forming apparatus, the combination pattern optimum coverage calculating portion 120 of the image processing apparatus disposed in the image forming apparatus calculates combination pattern optimum coverages respectively corresponding to a background combination pattern and a hidden character combination pattern, in a manner similar to the above-described process of calculating combination pattern optimum coverages respectively corresponding to a background combination pattern and a hidden character combination pattern. The calculated combination pattern optimum coverages are previously stored as default information in the combination pattern optimum coverage storage portion 101.

In this case, the coverage in the main scanning direction of the background combination pattern must be stepwisely changed in accordance with the changed density output characteristics. Therefore, a plurality of combination pattern optimum coverages corresponding to a plurality of background combination patterns that are different in coverages of a plurality of regions (element combination patterns) in the main scanning direction are previously stored in the combination pattern optimum coverage storage portion 101.

With respect to the combination pattern optimum coverage corresponding to the background combination pattern, a specific one of the plurality of background combination patterns is selected in accordance with the operation state (for example, the total of the number of recording media which are subjected to a print process, and that of recording media which are subjected to a copy process) of the image forming apparatus.

Then, without performing the preprocessing (from the acquiring of density optimum numbers and the calculation of combination pattern optimum coverages) shown in FIG. 18, the ground tint pattern image production process shown in FIG. 19 is performed. When instructions for producing the ground tint pattern image are given by the user or the administrator, the combination pattern producing portion 130 produces in step S122 a background combination pattern and a hidden character combination pattern in accordance with the operation state of the image forming apparatus, and based on the combination pattern optimum coverages respectively corresponding to the background combination pattern and hidden character combination pattern which are the default information stored in the combination pattern optimum coverage storage portion 101, in accordance with the operation state of the image forming apparatus. The background combination pattern and hidden character combination pattern which are thus produced are output to the ground tint pattern image producing portion 140.

Next, in the second method, during production or shipment of the image forming apparatus, the combination pattern optimum coverage calculating portion 120 of the image processing apparatus disposed in the image forming apparatus calculates combination pattern optimum coverages respectively corresponding to a background combination pattern and a hidden character combination pattern, and the combination pattern producing portion 130 produces a background combination pattern and a hidden character combination pattern based on the combination pattern optimum coverages. The background combination pattern and hidden character combination pattern themselves which are thus produced are previously stored as default information in a storage portion (not shown) of the image processing apparatus 10.

In this case, for a reason similar to that in the above-described first method, a plurality of background combination patterns that are different in coverages of a plurality of regions (element combination patterns) in the main scanning direction are previously stored in the storage portion (not shown).

With respect to the background combination patterns, a specific one of the plurality of background combination patterns is selected in accordance with the operation state (for example, the total of the number of recording media which are subjected to a print process, and that of recording media which are subjected to a copy process) of the image forming apparatus.

Then, without performing the preprocessing (from the acquiring of density optimum numbers and the calculation of combination pattern optimum coverages) shown in FIG. 18, the ground tint pattern image production process (in this case, a different process is performed in step S122) shown in FIG. 19 is performed. When instructions for producing the ground tint pattern image are given by the user or the administrator, the combination pattern producing portion 130 obtains in step S122 the background combination pattern and hidden character combination pattern which are the default information, from the storage portion (not shown) in accordance with the operation state of the image forming apparatus. The background combination pattern and hidden character combination pattern which are thus obtained are output to the ground tint pattern image producing portion 140.

In both the above-described first and second methods, with respect to the background combination pattern which, among the combination patterns to be combined respectively with the background pattern (background portion) and hidden character pattern (latent image portion) related to a ground tint pattern image, is to be combined with the background pattern (background portion), the combination pattern optimum coverage calculating portion 120 and the combination pattern producing portion 130 cooperate to produce a pattern having a plurality of regions in which the coverages are different in the main scanning direction.

In the above-described first method, it is configured so that the combination pattern optimum coverages calculated by the combination pattern optimum coverage calculating portion 120 of the image processing apparatus disposed in the image forming apparatus are previously stored. However, the method is not limited to this. Alternatively, combination pattern optimum coverages calculated by a processing apparatus which is different from the image processing apparatus may be stored as default information.

In the above-described second method, it is configured so that the background combination pattern and hidden character combination pattern which are produced by the combination pattern producing portion 130 of the image processing apparatus disposed in the image forming apparatus are previously stored. However, the method is not limited to this. Alternatively, combination pattern optimum coverages may be calculated by a processing apparatus which is different from the image processing apparatus, and a background combination pattern and a hidden character combination pattern may be produced based on the calculated combination pattern optimum coverages. Then, the background combination pattern and hidden character combination pattern which are produced by the processing apparatus may be stored as default information.

In the first exemplary embodiment, as described above, the image processing apparatus sets the background combination pattern which, among the combination patterns to be combined respectively with the background pattern (background portion) and hidden character pattern (latent image portion) related to a ground tint pattern image, is to be combined with the background pattern (background portion), as a pattern having a plurality of regions in which the coverages are different in the main scanning direction, and executes a process of combining the background combination pattern with the background pattern.

In the first exemplary embodiment, as described above, deterioration of the image quality (print image quality and copy image quality) is suppressed in both cases of printing and copying of a ground tint pattern.

Even when the output characteristics related to the density of the image forming unit (print engine) of the image forming apparatus are varied (the in-plane evenness or the density stability is varied), it is possible to suppress deterioration of the image quality (print image quality and copy image quality), in both cases of printing and copying of a ground tint pattern.

Moreover, the in-plane evenness is corrected in the image process performed by the image processing apparatus, without adjusting the image forming unit (print engine) in which the in-plane evenness is low. Therefore, deterioration of the image quality is suppressed in both cases of printing and copying of a ground tint pattern.

### Second Exemplary Embodiment

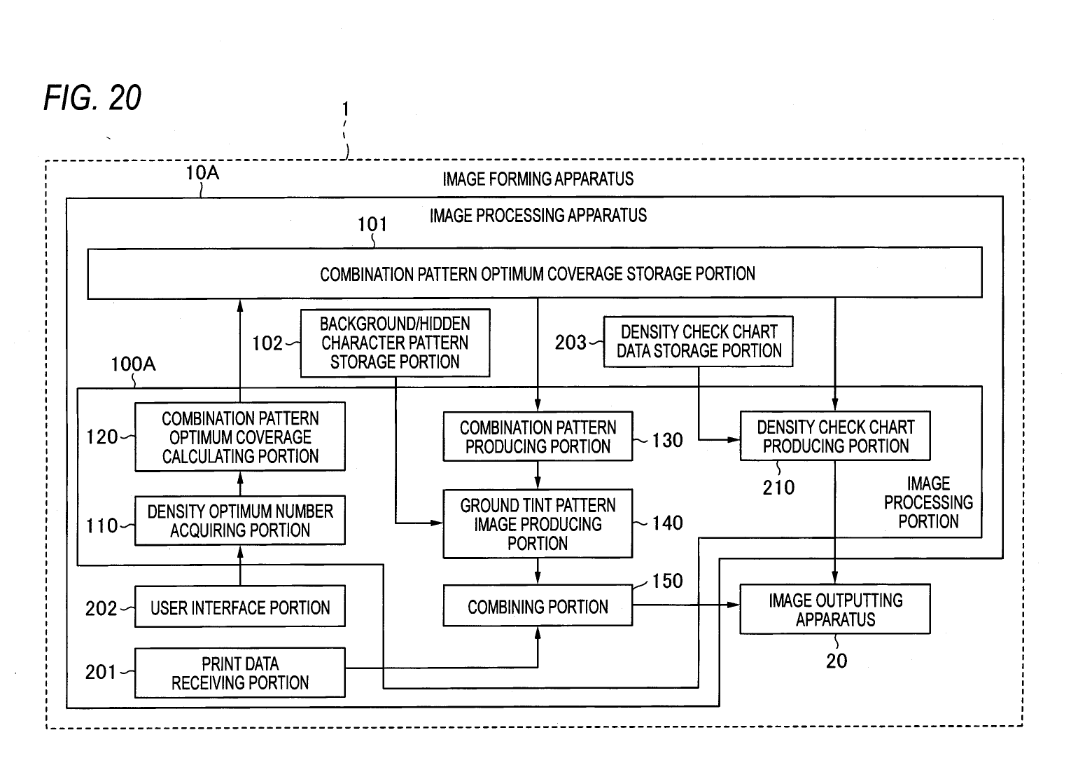

The functional configuration of an image forming apparatus having an image processing apparatus of a second exemplary embodiment will be described with reference to FIG. 20.

As shown in FIG. 20, the image forming apparatus 1 has the image processing apparatus 10A and an image outputting apparatus 20.

The image processing apparatus 10A has an image processing portion 100A, a print data receiving portion 201, a user interface portion 202, a density check chart data storage portion 203, and the combination pattern optimum coverage storage portion 101 and background/hidden character pattern storage portion 102 in the first exemplary embodiment shown in FIG. 1.

The print data receiving portion 201 receives print data which are transmitted from an external apparatus such as a computer.

The user interface portion 202 is configured by interfaces such as an operation panel for inputting instruction information such as instructions for outputting a ground tint pattern image density check chart image, and inputting input information such as an input of a density optimum number, and inputting/outputting apparatuses (an inputting apparatus, a displaying apparatus, and the like).

The density check chart data storage portion 203 stores density check chart data indicating a chart for checking the output characteristics related to the density of the image outputting apparatus 20 (hereinafter, the chart is referred to as “ground tint pattern image density check chart”).

The image processing portion 100A has a functional configuration in which a density check chart producing portion 210 is added to the image processing portion 100 of the first exemplary embodiment shown in FIG. 1.

In the second exemplary embodiment, the combination pattern optimum coverage calculating portion 120 causes the above-described density optimum numbers, and the combination pattern optimum coverages which are calculated based on the density optimum numbers, to be stored in the combination pattern optimum coverage storage portion 101.

The density check chart producing portion 210 reads out ground tint pattern image density check chart data from the density check chart data storage portion 203, and, in the case where the density optimum numbers are stored in the combination pattern optimum coverage storage portion 101, reads out the density optimum numbers therefrom, and produces ground tint pattern image density check chart image data based on the read out information.

The image outputting apparatus 20 includes an image forming unit (print engine) which performs a print process based on the ground tint pattern image density check chart image data output from the density check chart producing portion 210, and which performs a print (ground tint pattern print) process based on image data (image data in which a ground tint pattern image is incorporated into the image of the print object) output from the combining portion 150.

In FIG. 20, the components which exert functions similar to the components shown in FIG. 1 are denoted by the same reference numerals, and description of the components is omitted.

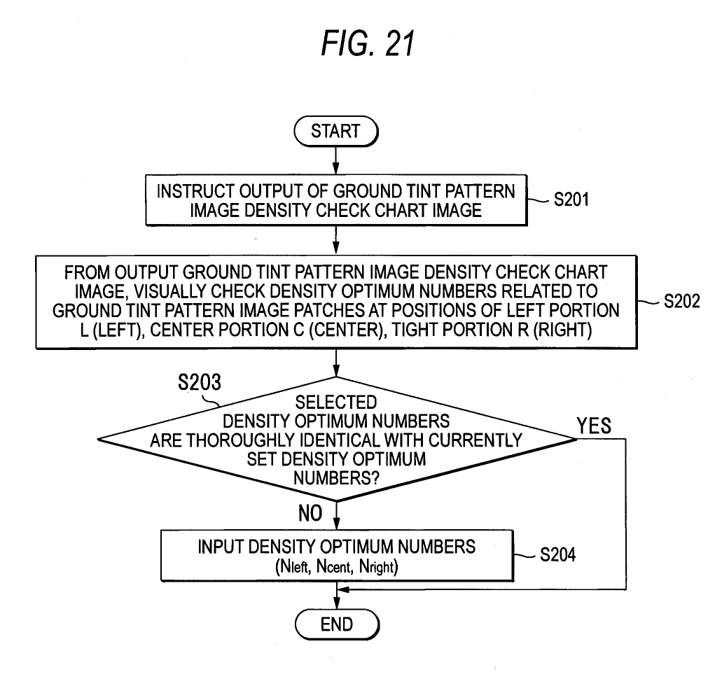

Next, a process of inputting a density optimum number by the user will be described with reference to FIG. 21.

The user operates the user interface portion 202 to instruct the output of the ground tint pattern image density check chart image (step S201).

The density check chart producing portion 210 which receives the output instructions produces the ground tint pattern image density check chart image data, and outputs the data to the image outputting apparatus 20. The image outputting apparatus 20 print-outputs the ground tint pattern image density check chart image based on the received ground tint pattern image density check chart image data.

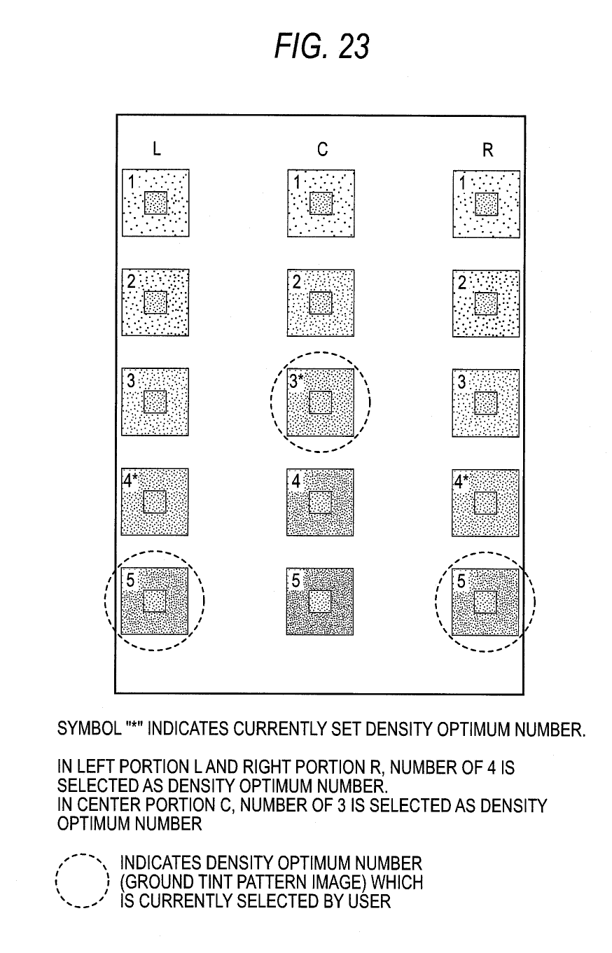

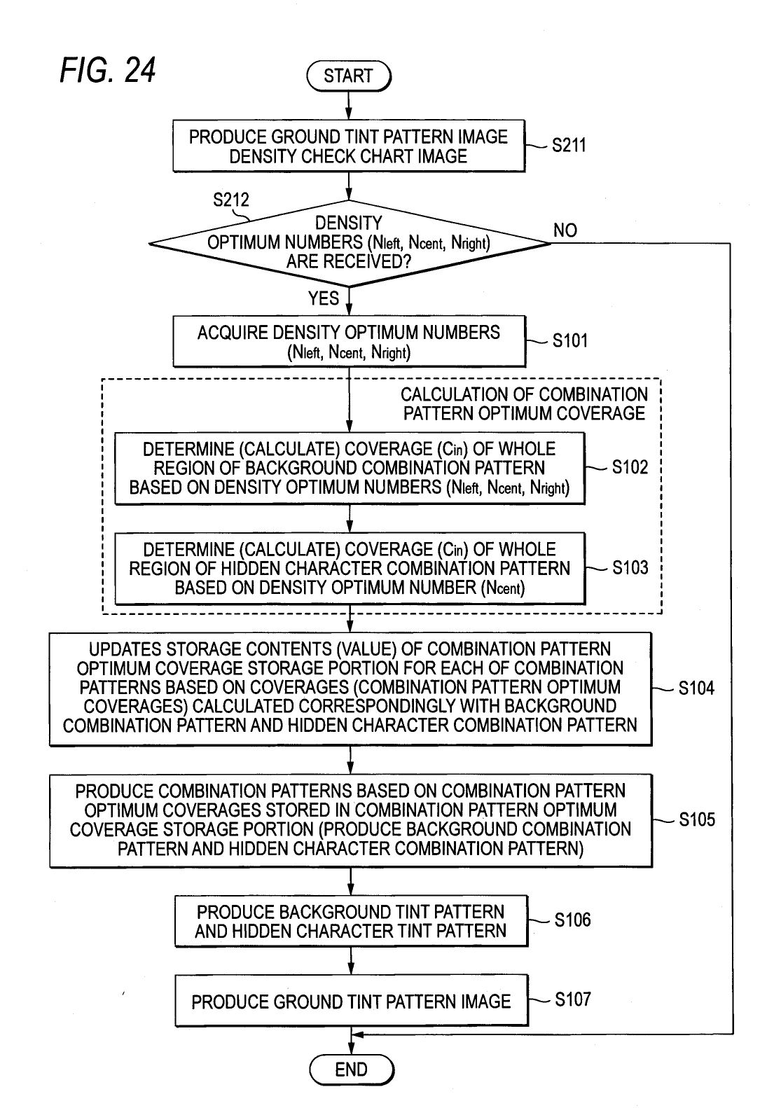

FIGS. 23 and 24 show an example of the ground tint pattern image density check chart image output from the image outputting apparatus 20.

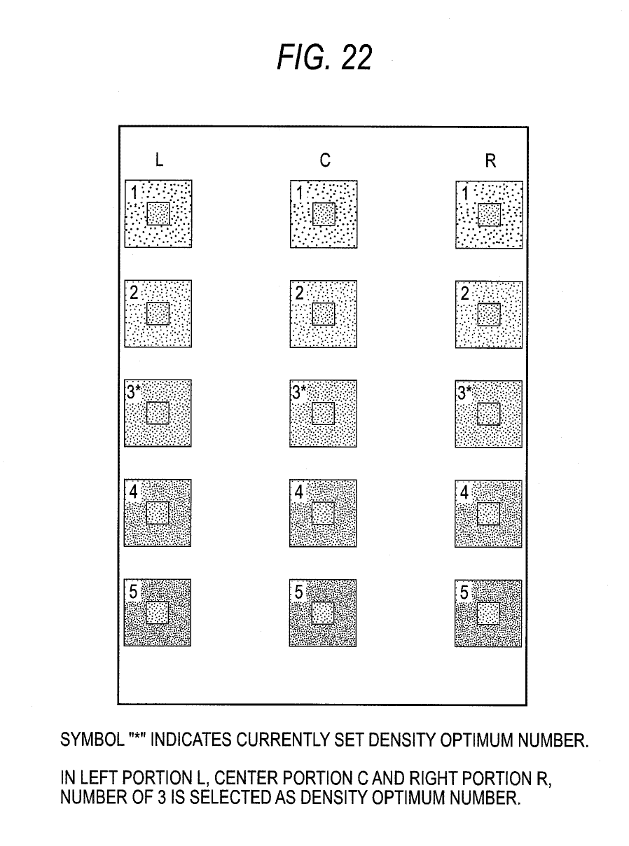

In the example shown in FIG. 22, the contents shown in FIG. 3A are changed so that, in each of the ground tint pattern image patches L3, C3, R3, “*” is affixed to the number of 3. The characteristics in this case are identical with those of the contents shown in FIG. 3A.

In the example shown in FIG. 23, the contents shown in FIG. 4A are changed so that, in each of the ground tint pattern image patches L4, R4, “*” is affixed to the number of 4, and, in the ground tint pattern image patch C3, “*” is affixed to the number of 3. The characteristics in this case are identical with those of the contents shown in FIG. 4A.

The symbol “*” indicates the currently set density optimum numbers, i.e., the density optimum numbers of the left portion L, the center portion C, and the right portion R which are stored in the combination pattern optimum coverage storage portion 101.

Here, it is assumed that the image outputting apparatus 20 outputs the ground tint pattern image density check chart image shown in FIG. 23.

The user views the thus output ground tint pattern image density check chart image (for example, see FIG. 23) to check and select density optimum numbers related to the ground tint pattern image patches at the positions of the left portion L (Left), the center portion C (Center), and the right portion R (Right) (step S202), and then determines whether or not the selected density optimum numbers are thoroughly identical with the numbers corresponding to the symbol “*” which is indicated in the output ground tint pattern image density check chart image, i.e., the currently set density optimum numbers (step S203).

If it is determined that the currently selected density optimum numbers are not thoroughly identical with the currently set density optimum numbers (the numbers affixed with “*”) (at least one of the density optimum numbers is different), the user operates the user interface portion 202 to input the currently selected density optimum numbers (N_{left}, N_{cent}, N_{right}) (step S204).

In this example, N_{left}=5, N_{cent}=3, and N_{right}=5 are input as the density optimum numbers, respectively.

If step S204 is ended, or if the user determines that the density optimum numbers which are selected in step S203 are thoroughly identical with the currently set density optimum numbers, the input process is ended.

Next, a ground tint pattern image production process performed by the image processing apparatus will be described with reference to FIG. 24.

In the ground tint pattern image production process, a procedure in which steps S211 and S212 are added to that of the ground tint pattern image production process in the first exemplary embodiment shown in FIG. 10 is performed.

In the ground tint pattern image production process, the preconditions are as follows. It is assumed that a ground tint pattern image density check chart image which is a print object, and which is printed by the image outputting apparatus 20 of the image forming apparatus has the contents shown in FIG. 23, and that a result of an output of the ground tint pattern image (print sample) which is produced by the image outputting apparatus 20 under the characteristics shown in FIG. 4B has the contents shown in FIG. 9B. Furthermore, it is assumed that the user visually selects the ground tint pattern image patches L5, C3, R5 as a ground tint pattern image patch in which the density difference between the background tint pattern and the hidden character tint pattern is minimum.

In the image processing apparatus 10A, when the user interface portion 202 receives information of instructions for producing a ground tint pattern image density check chart image, the density check chart producing portion 210 of the image processing portion 100A reads out ground tint pattern image density check chart data from the density check chart data storage portion 203, and, in the case where the density optimum numbers are stored in the combination pattern optimum coverage storage portion 101, reads out the density optimum numbers therefrom, and produces ground tint pattern image density check chart image data based on the read out information (step S211). Thereafter, the image data are output to the image outputting apparatus 20.

Next, the image processing portion 100A determines whether the density optimum numbers (N_{left}, N_{cent}, N_{right}) are received through the user interface portion 202 or not (step S212). If it is determined that the density optimum numbers are received, processes which are similar to those of above-described steps S101 to S107 are performed. By contrast, if it is determined that the density optimum numbers are not received, the process is ended.

Incidentally, if the image processing portion 100A receives the density optimum numbers through the user interface portion 202, the density optimum number acquiring portion 110 acquires the above-described density optimum numbers (N_{left}, N_{cent}, N_{right}) such as N_{left}=5, N_{cent}=3, and N_{right}=5. Detailed description of the processes of step S102 to S107 is omitted.

In step S104, the combination pattern optimum coverage calculating portion 120 stores the above-described density optimum numbers, and combination pattern optimum coverages which are calculated based on the density optimum numbers, in the combination pattern optimum coverage storage portion 101.

In the second exemplary embodiment, as described above, even when the output characteristics related to the density of the image forming unit (print engine) of the image outputting apparatus constituting the image forming apparatus are varied (the in-plane evenness or the density stability is varied), it is possible to suppress deterioration of the image quality (print image quality and copy image quality), in both cases of printing and copying of a ground tint pattern.

### Third Exemplary Embodiment

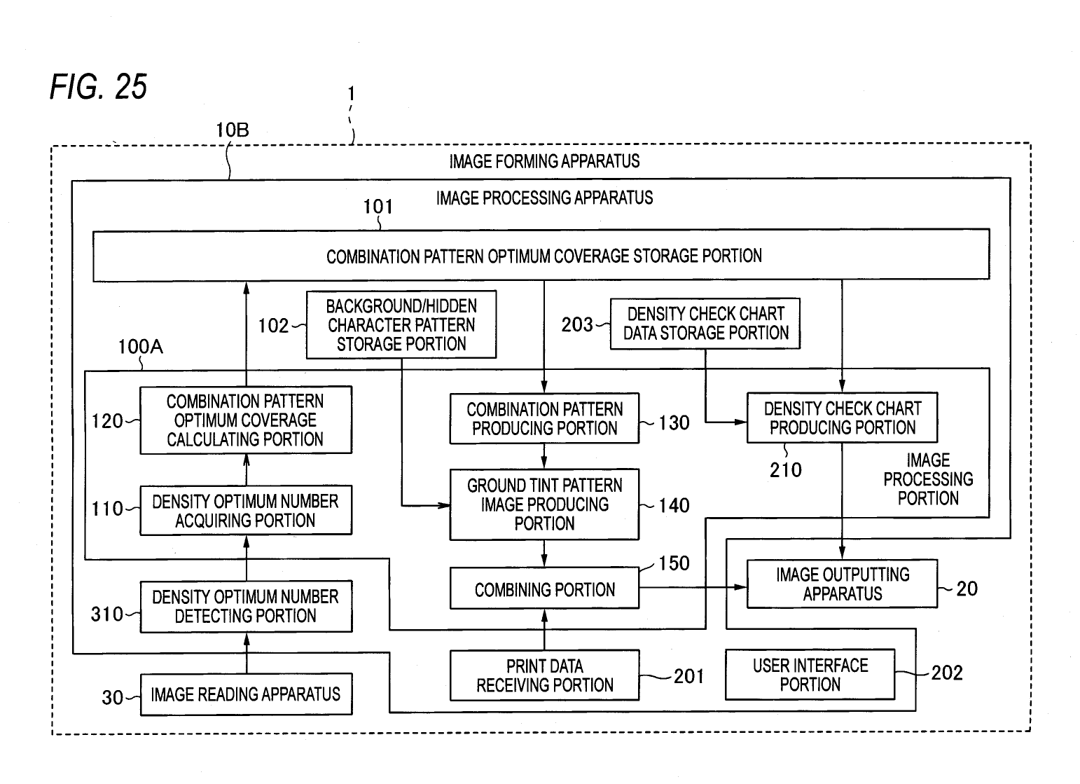

The functional configuration of an image forming apparatus having an image processing apparatus of a third exemplary embodiment will be described with reference to FIG. 25.

The image forming apparatus 1 shown in FIG. 25 has the functional configuration in which, in the image forming apparatus 1 of the second exemplary embodiment shown in FIG. 20, the image processing apparatus 10A is replaced with an image processing apparatus 10B, and an image reading apparatus 30 is added.

For example, the image reading apparatus 30 is a scanner which is an example of an imaging unit, optically reads a recording medium (printed matter) which is output from the image outputting apparatus 20, and on which a ground tint pattern image density check chart image is printed, and outputs image data (scan data) corresponding to a result of the reading, i.e., the ground tint pattern image density check chart image to the image processing apparatus 10B.

The image processing apparatus 10B has the functional configuration in which a density optimum number detecting portion 310 is added to the image processing apparatus 10A shown in FIG. 20.

The density optimum number detecting portion 310 selects, among, for example, fifteen ground tint pattern image patches in 3 columns by 5 rows, the ground tint pattern image patch in which the difference between the density of the background tint pattern and that of the hidden character tint pattern is minimum, in each column, based on the ground tint pattern image density check chart image (scan data) received from the image reading apparatus 30. Moreover, the portion detects the number allocated to the ground tint pattern image patch which is selected in each column, as the density optimum number.

Furthermore, the density optimum number detecting portion 310 outputs the thus detected density optimum numbers to the image processing portion 100A.

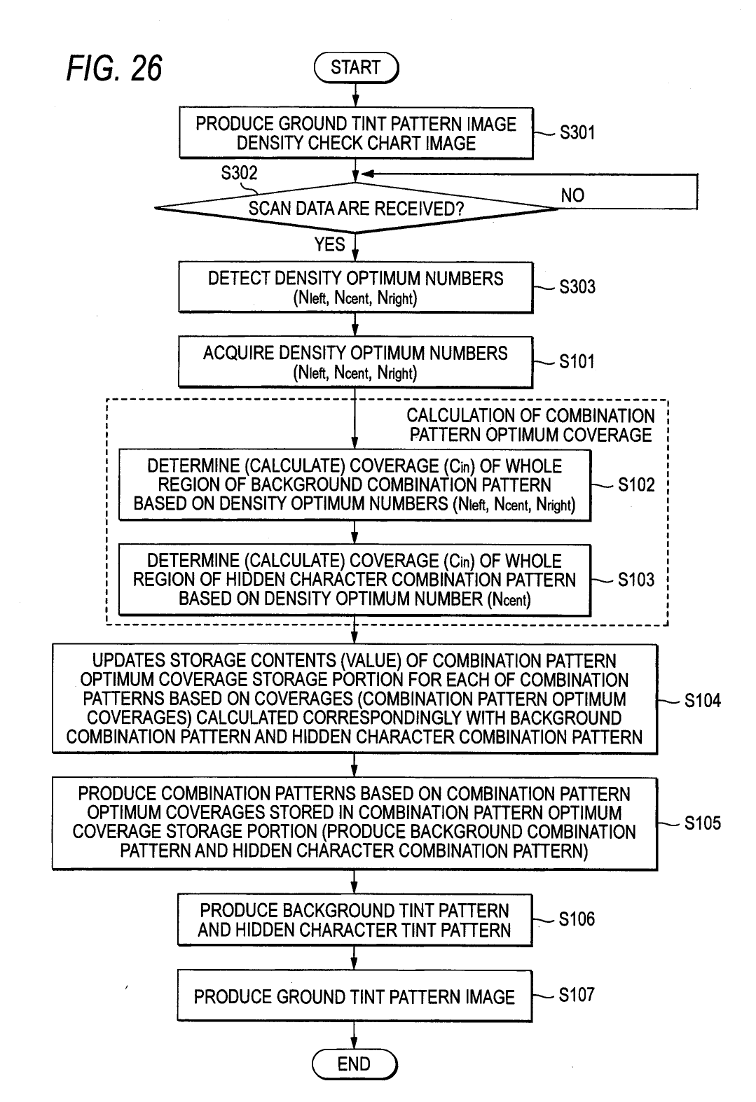

Next, a ground tint pattern image production process performed by the image processing apparatus will be described with reference to FIG. 26.

The ground tint pattern image production process performs a procedure in which steps S301 to S303 are added to that of the ground tint pattern image production process in the first exemplary embodiment shown in FIG. 10.

Initially, the user operates the user interface portion 202 to instruct the output of the ground tint pattern image density check chart image.

When the density check chart producing portion 210 which receives the output instructions produces the ground tint pattern image density check chart image data, and outputs the data to the image outputting apparatus 20, the image outputting apparatus 20 print-outputs the ground tint pattern image density check chart image based on the received ground tint pattern image density check chart image data.

Here, it is assumed that the recording medium (printed matter) which is output from the image outputting apparatus 20, and on which the ground tint pattern image density check chart image is printed has the contents shown in FIG. 23, and a result of an output of the ground tint pattern image (print sample) which is produced by the image outputting apparatus 20 under the characteristics shown in FIG. 4B has the contents shown in FIG. 9B.

In the third exemplary embodiment, without performing the viewing of the output recording medium (on which the ground tint pattern image density check chart image is printed), the user sets the recording medium in the image reading apparatus 30, and operates an operating portion (not shown) of the image reading apparatus 30 to issue instructions for reading.

The image reading apparatus 30 which receives the read instructions optically reads the set recording medium (printed matter), i.e., the recording medium (printed matter) on which the ground tint pattern image density check chart image (see FIG. 23) is printed, and outputs image data (scan data) corresponding to a result of the reading, i.e., the ground tint pattern image density check chart image to the image processing apparatus 10B.

In the image processing apparatus 10B, when the user interface portion 202 receives information of instructions for producing a ground tint pattern image density check chart image, the density check chart producing portion 210 of the image processing portion 100A reads out ground tint pattern image density check chart data from the density check chart data storage portion 203, and, in the case where the density optimum numbers are stored in the combination pattern optimum coverage storage portion 101, reads out the density optimum numbers therefrom, and produces ground tint pattern image density check chart image data based on the read out information (step S301). Thereafter, the image data are output to the image outputting apparatus 20.

In the image processing portion 100A, next, the density optimum number detecting portion 310 determines whether the scan data are received from the image reading apparatus 30 or not (step S302), and, if it is determined that the scan data are not received, waits until the scan data are received.

By contrast, if it is determined that the scan data are received, the density optimum number detecting portion 310 selects, among, for example, fifteen ground tint pattern image patches in 3 columns by 5 rows, the ground tint pattern image patch in which the difference between the density of the background tint pattern and that of the hidden character tint pattern is minimum, in each column, based on the scan date, i.e., the ground tint pattern image density check chart image (see FIG. 23). Moreover, the portion detects the number allocated to the ground tint pattern image patch which is selected in each column, as the density optimum number.

Here, it is assumed that the density optimum number detecting portion 310 selects the ground tint pattern image patches L5, C3, R5 as a ground tint pattern image patch in which the density difference between the background tint pattern and the hidden character tint pattern is minimum.

Namely, it is assumed that N_{left}=⁵, N_{cent}=3, and N_{right}=5 are selected as the density optimum numbers.

The thus detected density optimum numbers (N_{left}=5. N_{cent}=3, and N_{right}=5) are given to the density optimum number acquiring portion 110 of the image processing portion 100A.

Thereafter, processes which are similar to those of above-described steps S101 to S107 are performed.

In step S104, the combination pattern optimum coverage calculating portion 120 stores the above-described density optimum numbers, and combination pattern optimum coverages which are calculated based on the density optimum numbers, in the combination pattern optimum coverage storage portion 101.

In the third exemplary embodiment, as described above, the user is not required to perform the work of viewing a printing medium (printed matter) on which the ground tint pattern image density check chart image is printed, and selecting the density optimum numbers, as compared with the case of the second exemplary embodiment.

### Fourth Exemplary Embodiment

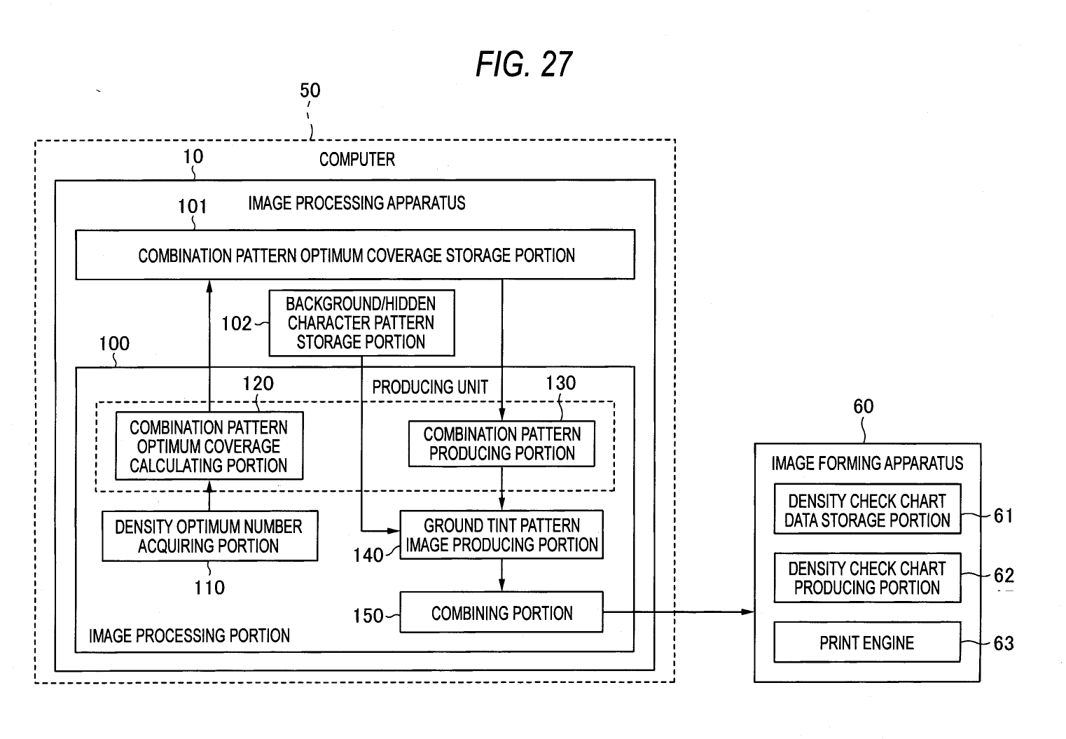

The functional configuration of a computer which is an example of an information processing apparatus having an image processing apparatus of a fourth exemplary embodiment will be described with reference to FIG. 27.

As shown in FIG. 27, the computer 50 has the image processing apparatus 10 of the first exemplary embodiment shown in FIG. 1, and an inputting apparatus, displaying apparatus, and storage apparatus which are not shown.

The image processing apparatus 10 has the same function as the case of the first exemplary embodiment, and hence its description is omitted.

An image forming apparatus 60 has a density check chart data storage portion 61 and density check chart producing portion 62 which have functions similar to the density check chart data storage portion 203 and density check chart producing portion 210 in the second exemplary embodiment shown in FIG. 20, respectively, and a print engine 63 which functions as an image forming unit that performs an image formation process.

Also in the fourth exemplary embodiment, the user selects density optimum numbers while viewing a recording medium (printed matter) which is output from the print engine 63 of the image forming apparatus 60, and on which a ground tint pattern image density check chart image (for example, see FIG. 23) is printed.

Then, the user operates an inputting apparatus (not shown) to input corresponding density optimum numbers into setting columns of “N_{left}=”, “N_{cent}=”, and “N_{right}=” of an input screen which is displayed on a displaying portion of the displaying apparatus (not shown), and which is used for inputting density optimum numbers. The density optimum numbers are given to the image processing apparatus 10 of the computer 50.

The image processing apparatus 10 to which the density optimum numbers are given as described above performs processes (see FIG. 10) which are similar to those in the first exemplary embodiment. As a result, one image (image data) in which the image of the print object is combined with a ground tint pattern image is produced, and the data (image data) after the combination are output toward the image forming apparatus 60.

In an application example of the fourth exemplary embodiment, the image forming apparatus 60 may have the image processing apparatus in any one of the first to third exemplary embodiments.

In this case, in image processing apparatus, instructions for producing a ground tint pattern image which is to be applied to print data of all print objects is issued by, for example, the administrator, and information of the instructions for producing is stored in the storage portion (or the storage area) which is to hold information of instructions for producing a ground tint pattern image.

According to the configuration, even in the case where print data (print data having no ground tint pattern image) into which a ground tint pattern image is not incorporated is transmitted from the computer to the image forming apparatus, the image forming apparatus performs the process of producing a ground tint pattern image, then combines the received print data with the ground tint pattern image, and thereafter performs an image formation process (printing of a ground tint pattern). This means that the printing of a ground tint pattern is forcibly performed.

In the case where print data (print data having a ground tint pattern image) into which a ground tint pattern image is incorporated is transmitted from the computer to the image forming apparatus, the image forming apparatus gives preference to the received print data (print data having a ground tint pattern image), and performs an image formation process (printing of a ground tint pattern) without performing the process of producing a ground tint pattern image by the image forming apparatus.

In the fourth exemplary embodiment, as described above, similarly with the first exemplary embodiment, deterioration of the image quality (print image quality and copy image quality) is suppressed in both cases of printing and copying of a ground tint pattern.

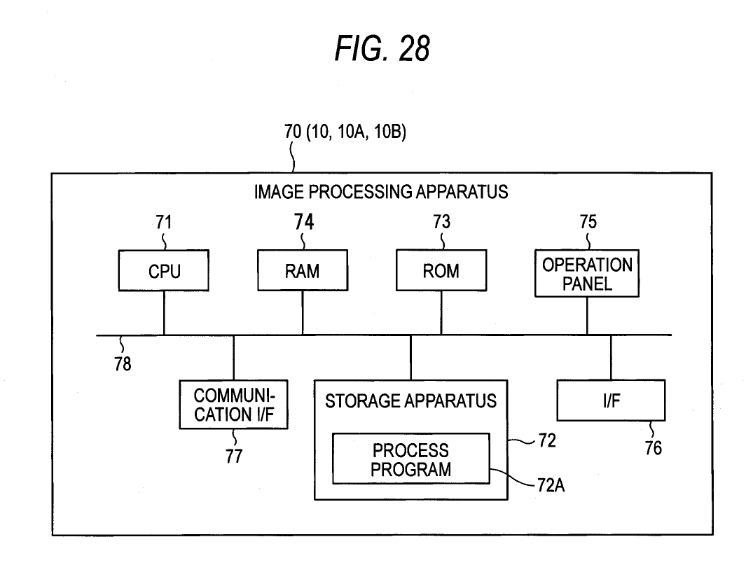

Next, the hardware configuration of the image processing apparatus in the first to fourth exemplary embodiments will be described with reference to FIG. 28.

As shown in FIG. 28, an image processing apparatus 70 has a CPU 71, a storage apparatus 72, a ROM 73, a RAM 74, an operation panel 75, an I/F 76, and a communication I/F 77. The components 71 to 77 are connected a system bus 78.

The image processing apparatus 70 corresponds to the image processing apparatus 10 (the first and fourth exemplary embodiments), the image processing apparatus 10A (the second exemplary embodiment), and the image processing apparatus 10B (the third exemplary embodiment).

The storage apparatus 72 is, for example, a hard disk drive, and stores various kinds of installed programs such as software (programs) and process program 72A for realizing the function of the image processing portion 100 or 100A.

The function of the image processing portion 100 includes software (programs) for realizing the functions of the components (components 110 to 150) which are applied in the case of realizing the first or fourth exemplary embodiment, and which are shown in FIG. 1 (see FIG. 27). The function of the image processing portion 100A includes software (programs) for realizing the functions of the components (components 110 to 150) which are applied in the case of realizing the second or third exemplary embodiment, and which are shown in FIG. 20 (see FIG. 25).

The process program 72A includes software (programs) corresponding to the procedure (shown in FIGS. 10, 18, and 19 or FIG. 24) of the above-described process of producing a ground tint pattern image.

For example, the process program 72A includes at least: an execution process of executing a process of combining a pattern (background combination pattern) that is to be applied as a pattern (background combination pattern) which, among patterns (the background combination pattern and the hidden character combination pattern) to be combined respectively with the background portion (background pattern) and latent image portion (hidden character pattern) related to a ground tint pattern image, is to be combined with the background portion (background combination pattern), and that has a plurality of regions in which the coverages are different in the main scanning direction, with the background portion (background pattern); or a production process of, with respect to the pattern (background pattern) to be combined with the background portion (background pattern), producing a pattern having a plurality of regions in which the coverages are different in the main scanning direction.

The execution process is performed by the ground tint pattern image producing portion 140, and the production process is performed by the cooperation of the combination pattern optimum coverage calculating portion 120 and the combination pattern producing portion 130.

The storage apparatus 72 has the function of the combination pattern optimum coverage storage portion 101.

The ROM 73 is a read-only memory, and stores information which is necessary for the image processing portion 100, 100A to perform the image process, communication protocol information for performing communication with an external apparatus, and the like.

Furthermore, the ROM 73 has the function of the background/hidden character pattern storage portion 102. Alternatively, the storage apparatus 72 may have the function of the background/hidden character pattern storage portion 102.

The RAM 74 is a random access memory, and stores: programs including the process program 72A read from the storage apparatus 72, and data; information read from the ROM 73; information acquired by the density optimum number acquiring portion 110; a result (the combination pattern optimum coverages and the like) of the calculation process performed by the combination pattern optimum coverage calculating portion 120; a result (the background combination pattern, the hidden character combination pattern, and the like) of the production process performed by the combination pattern producing portion 130; a result (the ground tint pattern image) of the production process performed by the ground tint pattern image producing portion 140; data which are transmitted and received by the communication I/F 77; and the like.

The operation panel 75 has the function of the user interface, and includes, for example, an inputting portion for inputting information such as a density optimum number, and a displaying portion on which display information is displayed. In the case where the hardware configuration in the fourth exemplary embodiment is to be realized, the operation panel 75 is not necessary.

The I/F 76 is configured by one or a plurality of interfaces which govern communication with peripheral apparatuses. For example, the I/F governs communication with the image outputting apparatus in first and second exemplary embodiments, that with the image outputting apparatus and the image reading apparatus in the third exemplary embodiment, and that with peripheral apparatuses such as inputting/outputting apparatuses (the inputting apparatus, the displaying apparatus) in the fourth exemplary embodiment. In the case where the hardware configuration in the fourth exemplary embodiment is to be realized, the inputting/outputting apparatuses (the inputting apparatus, the displaying apparatus) connected to the I/F 76 exert the function of the user interface.

The communication I/F 77 is used for communicating with an external apparatuses through a communication line (the Internet or the like), and, for example, governs communication with a computer which transmits print data, in the first to third exemplary embodiments, and that with the image forming apparatus which prints print data, in the fourth exemplary embodiment.

The CPU 71 is a central processing unit, reads programs including the process program 72A from the storage apparatus into the RAM 74, and executes the programs, thereby realizing the function of the above-described image processing portion 100 or 100A, and a processing function corresponding to the process program 72A. Moreover, the CPU 71 controls the whole of the image processing apparatus 70.

Although the invention conducted by the inventors has been specifically described on the basis of the exemplary embodiments, the exemplary embodiments disclosed in the specification are exemplarily shown in all aspects, and it is to be understood that the invention is not restricted to the disclosed techniques. Namely, the technical scope of the invention should not be restrictively interpreted on the basis of the description of the exemplary embodiments, and should be interpreted in accordance with the description of the appended claims. The invention includes techniques equivalent to those set forth in the claims, and all changes within the scopes of the claims.

In the case where a program is used, the program may be provided through a network, or being stored in a recording medium such as a CD-ROM.

Namely, the invention is not limited to the case where programs including the process program are recorded in a storage apparatus such as a hard disk, and the programs may be provided in the following manners.

For example, the programs may be stored in a ROM, and a CPU may load the programs from the ROM to a main storage apparatus, and then execute the programs.

Alternatively, the programs may be stored in a computer readable storage medium such as a DVD-ROM, a CD-ROM, a MO (magnetooptical disk), or a flexible disk, and then distributed.

Alternatively, the image processing apparatus and the like may be connected to a server apparatus or a host computer through a communication line (for example, the Internet), and the programs may be downloaded from the server apparatus or the host computer, and then executed. In this case, the download destination of the programs may be a memory such as a RAM, or a storage apparatus (storage medium) such as a hard disk.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

The image processing apparatus of the invention may be applied to a dedicated image processing apparatus, an image forming processing which is incorporated in a printer that is an example of an image forming apparatus, or an image processing apparatus which is incorporated in an image forming apparatus (so-called multifunction machine) having a plurality of image forming functions such as a print function and a copy function.

The image forming apparatus of the invention may be applied to an image forming apparatus which forms a color image or a monochrome image.

Although the case where the image forming apparatus of the invention is applied to an image forming apparatus which performs the toner recording process has been described, the invention may be applied to, for example, an ink-jet image forming apparatus in which the recording process is performed by means of ejected ink.
1 image forming apparatus
10, 10A, 10B, 70 image processing apparatus
20 image outputting apparatus
30 image reading apparatus
50 computer
71 CPU
72 storage apparatus
72A process program
73 ROM
74 RAM
75 operation panel
76 I/F
77 communication I/F
100, 100A image processing portion
101 combination pattern optimum coverage storage portion
102 background/hidden character pattern storage portion
110 density optimum number acquiring portion
120 combination pattern optimum coverage calculating portion
130 combination pattern producing portion
140 ground tint pattern image producing portion
150 combining portion
201 print data receiving portion
202 user interface portion
203 density check chart data storage portion
210 density check chart producing portion
310 density optimum number detecting portion

What is claimed is:

1. An image processing apparatus comprising:
a combining module that respectively combine a plurality of first patterns and a plurality of second patterns each corresponding to the first patterns,
wherein respective densities of the first patterns are different from each other,
at least one of the second patterns include a plurality of regions where respective coverages are different in a main scanning direction.

2. The image processing apparatus according to claim 1 further comprising a generating module that generate the at least one of the second pattern based on output density characteristics of an image forming apparatus,
wherein the first patterns include a background portion pattern and a latent image portion pattern, and
the at least one of the second pattern corresponds to the background portion pattern.

3. An image processing apparatus wherein,
a combining module that respectively combine a first patterns and a second patterns each corresponding to the first patterns,
wherein the first pattern includes a background portion pattern and a latent image portion pattern,
the second pattern includes a background composite pattern to be combined with the background portion pattern and a latent image composite pattern to be combined with the latent image portion pattern,
the background composite pattern include a plurality of regions where respective coverages are different in a main scanning direction.

4. The image processing apparatus according to claim 3 further comprising a generating module that generate the background composite pattern based on output density characteristics of an image forming apparatus.

5. The image processing apparatus according to claim 4 further comprising an acquiring module that acquires information for correcting the output density characteristics,
the generating module generates the background composite pattern based on the information acquired by the acquiring module.

6. The image processing apparatus according to claim 5, wherein
the acquiring unit acquires information indicating a ground tint pattern image patch in which, with respect an output image in which ground tint pattern image patches including a background pattern and a latent image pattern are two-dimensionally formed at a plurality of positions in a main scanning direction and a sub scanning direction, and the plurality of background patterns in the sub scanning direction are formed respectively based on different density parameters, a difference between a density of the background pattern and a density of the latent image pattern is minimum, at each of a plurality of positions in the main scanning direction.

7. An image forming apparatus comprising an image processing apparatus that includes:
a combining module that respectively combine a plurality of first patterns and a plurality of second patterns each corresponding to the first patterns,
wherein respective densities of the first patterns are different from each other,
at least one of the second patterns include a plurality of regions where respective coverages are different in a main scanning direction.

8. A computer readable medium storing a program causing a computer to execute a process for image processing, the process comprising:
respectively combining a plurality of first patterns and a plurality of second patterns each corresponding to the first patterns,
wherein respective densities of the first patterns are different from each other,
at least one of the second patterns include a plurality of regions where respective coverages are different in a main scanning direction.
